(19) United States
(12) Patent Application Publication
(10) Pub. No.: US 2011/0245105 A1
(43) Pub. Date: Oct. 6, 2011

(54) Methods and Kits for Direct Detection and Susceptibility Profiling of Beta-Lactam Resistant Bacteria

(75) Inventor: Nathan Citri, Jerusalem (IL)

(73) Assignee: YISSUM RESEARCH DEVELOPMENT COMPANY OF THE HEBREW UNIVERSITY OF JERUSALEM

(21) Appl. No.: 13/133,034

(22) PCT Filed: Dec. 8, 2009
(86) PCT No.: PCT/IL09/01161

§ 371 Date: Jun. 6, 2011

Related U.S. Application Data
(60) Provisional application No. 61/120,793, filed on Dec. 8, 2008.
(60) Provisional application No. 61/167,311, filed on Apr. 7, 2009.

(51) Int. Cl. C40B 30/06; C40B 40/04

(52) U.S. Cl. 506/10; 506/15

(57) ABSTRACT

The present invention relates to a convenient, flexible and cost-efficient technology for detection and resistance-profiling of bacteria, enabling effective, evidence-based treatment of infections. The invention provides methods and modular kits for the rapid and direct detection of beta-lactam resistant bacteria in a test sample, and optionally for susceptibility profiling of the bacteria, by directly determining hydrolysis product/s of beta-lactam antibiotic substrates in the tested sample. The invention also provides methods and modular kits for the rapid and direct detection of the presence of multidrug resistant bacteria in a test sample.

This application is a 371 National Stage Application of PCT/IL2009/001161 (filed Dec. 8, 2009; pending), and claims priority to U.S. Patent Application Ser. Nos. 61/120,793 (filed 8 Dec., 2008, now lapsed) and 61/167,311 (filed 7 Apr., 2009; now lapsed), each of which applications is herein incorporated by reference in its entirety.

### FIELD OF THE INVENTION

The present invention relates to methods and test kits for rapid and direct detection of resistant bacteria in a test sample. More particularly, the present invention relates to methods and test kits for the rapid detection of beta-lactam resistant bacteria and susceptibility profiling of a test sample by directly determining hydrolysis product/s of beta-lactam antibiotic substrate by the tested sample.

### BACKGROUND OF THE INVENTION

Throughout this application, various publications, including United States patents, are referenced by author and year and patents by number. The disclosures of these publications and patents and patent applications in their entireties are hereby incorporated by reference into this application in order to more fully describe the state of the art to which this invention pertains.

Beta-lactam antibiotics are indicated for the prophylaxis and treatment of bacterial infections caused by susceptible organisms. Beta-lactam antibiotics are bactericidal, and act by inhibiting the synthesis of the peptidoglycan layer of bacterial cell walls. At first, beta-lactam antibiotics were mainly active only against Gram-positive bacteria yet subsequent development of broad-spectrum beta-lactam antibiotics active against various Gram-negative organisms has increased their usefulness. However, bacteria showing marked resistance to several beta-lactam antibiotics have evolved. This resistance is now widespread among many genera of bacteria. Thus, practitioners must decide whether to start antibiotic treatment before obtaining evidence whether the choice of the antibiotic is appropriate, bearing in mind that a wrong choice will confer advantage on pathogens resistant to said antibiotic.

A problem with currently available antimicrobial susceptibility tests is their failure to reliably predict the in vivo effect and therefore the outcome of clinical therapy. Sometimes an antibiotic will fail to cure an infection even though the microorganism is susceptible to the antibiotic in the laboratory test. That is, the current routine laboratory tests can be misleading and give an over-optimistic impression of the therapeutic potential of antibiotics. These tests can therefore cause patients to be given ineffective treatments. In serious infections, this inadequacy of current laboratory tests can have fatal consequences.

There are many reasons for failures of antibiotic therapies that were initiated on the basis of antibiotic susceptibility tests. Some involve patient-related factors. Some involve pathogen-related factors. However one explanation is error arising from a deficiency in the antibiotic susceptibility test itself. That deficiency is that current routine antibiotic susceptibility tests do not detect the antibiotic-inactivating potential of some microorganisms in a mixed sample. Some microorganisms produce enzymes that inactivate antibiotics. Such enzymes, which are not reliably detected in routine antibiotic susceptibility tests, may cause sufficient antibiotic inactivation at the site of an infection in vivo leading to a treatment failure. Well known enzymes of this type are the beta-lactamases that certain bacteria produce to inactivate beta-lactam antibiotics. Beta-lactamases are bacterial enzymes that inactive beta-lactam antibiotics by hydrolysis of the beta-lactam bond. The molecular classification of beta-lactamases is based on the nucleotide and amino acid sequences in these enzymes. To date, four classes are recognized (A-D), correlating with the functional classification. Classes A, C, and D act by a serine-based mechanism, whereas class B or metallo-beta-lactamases need zinc for their action.

Administration of beta-lactam based antibacterial agents against the bacteria having developed a resistance to the beta-lactam based antibacterial agents not only would be a hopeless cure, but also might lead to spreading of new resistant bacteria. Indeed, the widespread increase in the occurrence of Multidrug-Resistant (MDR) bacteria that are resistant to more than one class of commonly-used beta-lactam antibiotics is, at least in part, the result of such antibiotics misuse. The emergence of MDR bacteria has posed a rapidly growing challenge to clinicians, and rapid identification of such bacteria is required for the effective treatment of patients and prevention of therapeutic failures and further exacerbation of bacterial resistance.

Accordingly, there is an urgent need to accelerate the detection of a multi-drug resistant bacterial infection. Furthermore, it is generally accepted that it is of utmost importance that, once detected, such infections should be treated as soon as possible with the appropriate drug or drug combination. Conventional procedures require time consuming steps consisting of cultivation and subsequent isolation of suspected pathogens followed by further cultivation for evaluation of the susceptibility of the suspected pathogen to the antibiotics under consideration. The entire process requires days before it has been completed and precious time is wasted before rational steps can be taken and evidence based treatment can be initiated.

In the beta-lactamase assay for Staphylococcus aureus, the expression of resistance enzymes is inferred by the production of a distinctive heaped-up margin of the inhibition zone around a penicillin antibiotic disk [Gill, V. J. et al., J. Clin. Microbiol. 14:437-40 (1981)]. Beta-lactamase production by many types of bacteria can also be detected chemically by testing the bacteria with an indicator substance such as nitrocefin [Oberhofer, T. R. et al., J. Clin. Microbiol. 15:196-9 (1982)]. These tests are reliable indicators only of beta-lactamase-determined resistance of Staphylococcus aureus, Staphylococcus epidermidis, Moraxella catarrhalis, Neisseria and Haemophilus species to certain types of penicillin antibiotics. They do not predict the potential for any other bacteria to resist these penicillins, and they do not predict the potential for any bacteria to be resistant to any of the other classes of beta-lactam antibiotics, such as cephalosporins, cephamycins, monobactams, monocarbams, penems or carbapenems. In short, these are useful tests of limited scope. For tests of beta-lactam antibiotics, a more comprehensive test is needed to detect the activities of a potential variety of beta-lactamases in a certain sample against all beta-lactam antibiotics.

The double disk potentiation test (and its derivatives) involves strategically placing an amoxicillin/clavulanate or ticarcillin/clavulanate disk 20 to 30 mm from disks containing cefotaxime, ceftriaxone, ceftizoxime, ceftazidime, cefepime or aztreonam on an agar plate. It is therefore possible to determine if a strain of Enterobacteriaceae produces a special type of beta-lactamase known as an extended-spectrum beta-lactamase [Brun-Buisson, C. et al., Lancet. 302-306 (1987)]. The test is based on the ability of the beta-lactamase inhibitor, clavulanate, to inhibit the extended-spectrum beta-lactamase and prevent it from inactivating the cephalosporin or aztreonam antibiotics in the test. This is a special procedure, not a routine antibiotic susceptibility test, and detects only certain types of beta-lactamases. It is therefore inconvenient and limited in scope.

A variety of disk and dilution tests have been derived from the principle of the double disk test [for example, Cormican, M. G., et al. JCM. 34:1880-1884 (1996)]. That is, they use the ability of a beta-lactamase inhibitor to inhibit an extended-spectrum beta-lactamase to detect this type of beta-lactamase.

The three-dimensional test [Thomson, K. S., et al. U.S. Pat. No. 5,466,583] is an approach that partially fulfills the need for improved antibiotic susceptibility testing. In performing the direct form of the 3-dimensional test a standard quantity of the causative microorganism is uniformly spread over the surface of an agar plate in the usual manner for performing a disk diffusion test. However, in addition to technical problems connected with operating this procedure, it involves the time consuming step of incubation.

Several attempts have been made to shorten or modify the conventional procedure so that information relevant to evidence based decisions can be obtained days before the results of the standard testing become available.

The methods currently used for detecting the beta-lactamases are roughly divided into the following four methods: (1) chromogenic cephalosporin method (2) acidimetric method (3) iodometric method (4) UV method and (5) PCR detection.

In addition, there can be employed a cultivation method for comparing the minimum inhibitory concentrations (MIC). Principal among the commercially available products for detecting the beta-lactamases are: a product capable of indicating whether beta-lactamase is present or absent using the chromogenic cephalosporin method; a product capable of detecting the beta-lactamases belonging to the class A and class C using the acidimetric method; a product capable of detecting the class B beta-lactamase or ESBL using the cultivation method, and the like.

The chromogenic cephalosporin method uses cephalosporin that will cause a color change upon the cleavage of its beta-lactam ring by the application of beta-lactamase thereto. This method has the advantage that the detection sensitivity is excellent because the reagent itself results in a color change. However, the conventional commercially available products using the chromogenic cephalosporin method employ as a detection substrate nitrocefin (i.e., 3-[2,4-dinitrostyryl]-7-(2-thienylacetamido)-3-cephem-4-carboxylic acid. As mentioned before, nitrocefin is not hydrolyzed by most beta-lactamases and therefore has a limited scope, although the detection can be achieved in a short period of time, i.e., about 30 minutes.

The PCR methods employ gene amplification to detect the presence of DNA encoding beta-lactamase in bacterial samples. While this method is easy to implement in clinical laboratories since PCRs and trained technicians are usually available, it suffers serious limitations, as the bacterial sample used for the assay needs to be isolated, the different beta-lactamases require different amplification strategies and/or primers and the entire process requires a lengthy 30 hours. Schechner et al. [Schechner et al. Journal of Clinical Microbiology, 47(10):3261-3265 (2009)] describe an analysis of the PCR method in detection of carbapenamse-producing Klebsiella pneumniae. Although the authors focused on the relatively high sensitivity and specificity of this method, they also noted that during the analysis, the sensitivity changed from 92.2% to 96.3%, indicating that this method is highly dependent on the proficiency of the laboratory staff.

The most recent, and by far the most rapid method and test kits, yielding the necessary information, has been described by the present inventor in the pending U.S. patent application Ser. No. 12/594,085. This patent application demonstrates the characterization and identification of prokaryotic or eukaryotic cells present in a test sample, using an enzyme characterizing a specific strain of cells as a dual marker for the cell viability in the presence of a cell inhibitory agent, and as a structural marker for cell identification.

U.S. Pat. No. 4,381,343 by the present inventor teaches that the presence of beta-lactam antibiotics in test material such as food, infusions, vaccines, blood for transfusion, body fluids, etc., may be determined by seeding a nutrient medium with a beta-lactamase generating bacterium or spores thereof, applying a sample of said test material to a site on the so-called nutrient medium, then incubating the medium under conditions inductive to the generation of beta-lactamase by said bacteria and assaying the beta-lactamase thus produced.

Hence, like all other known procedures for the determination of bacterial sensitivity profiles the above mentioned inventions require incubation. The sample must be incubated under conditions that will allow significant synthesis of the enzyme. Although the incubation time can be remarkably short [60 to 90 minutes] when the bacteria to be tested are spore formers capable of rapidly synthesizing and secreting enzymes to be used as functional markers, most bacterial pathogens are not enzyme secreting spore formers.

The method of the present invention obviates the time-consuming steps of isolation and cultivation by applying a direct, novel approach for determination of drug resistance of a sample, that may comprise in some cases mixed population of resistant and susceptible bacteria.

In their paper “Don't Forget the Bacterial Threat—Antibiotic resistance is a much bigger problem than swine flu”, [The Wall Street Journal, (Aug. 12, 2009)], Mitchell et al. warns of the emerging threat of carbapenamase producing members of the Enterobacteriaceae family. These organisms have developed a resistance to the last-line of defense antibiotics used for their treatment, the carbapenems. The rapid spread of these infections requires an efficient method for their detection, but the current carbpenamase detection methodologies are insufficient.

One object of this invention is therefore to provide a rapid and incubation-free detection of beta-lactam degradation products in samples, indicating the resistance of the tested sample to particular bata-lactam antibiotics, thereby providing susceptibility profiling of a sample.

Another object of this invention is the rapid and incubation-free detection of MDR resistant bacteria in samples.

Another object of the invention is to provide a kit for detection of MDR resistant bacteria in samples.

Another object of this invention is the rapid and incubation-free detection of carbapenem resistant bacteria in samples.

These and other objects of the invention will become apparent as the description proceeds.

### SUMMARY OF THE INVENTION

In a first aspect, the present invention provides a method for the direct and rapid detection of beta-lactam destroying bacteria in a test sample. Optionally, the invention thus may further provide susceptibility profiling of the sample. According to certain embodiments, the method comprises the steps of: (a) providing an array comprising at least one beta-lactam antibiotic. Each of the beta-lactam antibiotics is located in a defined position in the array; (b) contacting aliquots of the un-cultured test sample with the beta-lactam antibiotics in the array of (a) under conditions allowing enzymatic activity and formation of a detectable product; and (c) directly determining the presence of hydrolysis product/s of the beta-lactam antibiotics in the array of (a) by suitable means. A positive determination of hydrolysis products of at least one beta-lactam antibiotic in the array of (a) indicates the existence of a beta-lactam hydrolyzing enzyme in the sample, thereby providing for the detection of beta-lactam resistant bacteria in the tested sample. It should be noted that according to certain embodiments, resistance of the bacteria in the test sample to the specific beta-lactam antibiotics is conferred by the beta-lactam hydrolyzing enzyme in the sample.

The invention further provides a method for the rapid detection of the presence of multidrug resistant (MDR) bacteria in a test sample.

A third aspect of the invention relates to a kit for the rapid detection of beta-lactam resistant bacteria in a test sample. Optionally, the kit of the invention may also provide susceptibility profiling of the tested sample. According to certain embodiments, the kit of the invention may comprise: (a) at least one means for collecting a sample to be tested. The kit of the invention further comprises (b) at least one compartment containing an array comprising at least one beta-lactam antibiotic. It should be noted that each of the beta-lactam antibiotics is located in a defined and recorded position in the array. Still further, the kit of the invention includes (c) at least one assay reagent for enabling enzymatic reaction hydrolyzing the beta-lactam antibiotics, by any beta-lactamase present in the sample; (d) at least one means for determining hydrolysis products of the beta-lactam antibiotics; (e) optionally, at least one control sample; and (f) instructions for carrying out the detection of beta-lactam destroying bacteria in the sample.

The invention further provides a kit for the rapid detection of the presence of multidrug resistant (MDR) bacteria in a test sample.

These and other aspects of the invention will become apparent by the hand of the following drawings.

### BRIEF DESCRIPTION OF THE FIGURES

FIG. 1. Rapid detection of carbapenem-resistant bacteria

Activated ART strip impregnated with 30 μL of an aqueous solution of 30, 0, 20, 15, 10 and 5.0 mg/mL imipenem (Ipm) or ertapenem (Etp) in positions 1, 2, 3, 4 and 5 on the strip, respectively, was placed in contact with a slide streaked with a urine pellet sample (Ipm+Sam. or Etp+Sam.), or an unstreaked slide (Ipm Cont. or Etp Cont.), for about 5 to 10 minutes at about 30° C. to 40° C. for a clear decolorization reaction to appear. Abbreviations: Cont. (control), Etp. (ertapenem), Ipm. (imipenem), sam. (sample).

FIG. 2. Modular bacterial resistance detection kit

The self-contained kit consists of a slide attached to a lid which is pre-treated with Assay Reagent solution. Filter paper segments impregnated each with a single beta-lactam antibiotic substrate are attached to a slide in a predetermined position. Beta lactamase is spotted on the slide corner, and a beta-lactam substrate is spotted on the corresponding location on the lid. (1) Urine sample pellets are streaked on the slide and (2) Activator solution is applied to the lid. (3) The lid is brought in contact with the slide until striking decolorization occurs in the positive control. (4) The resulting decolorization is scanned and analyzed. Local decolorization of the indicator corresponding to a specific segment location reveals the formation of beta-lactam hydrolysis products and thereby provides evidence of the sample harboring bacteria resistant to the specific beta-lactam antibiotic impregnating said segment.

FIG. 3 the modular kit for detection of CRE

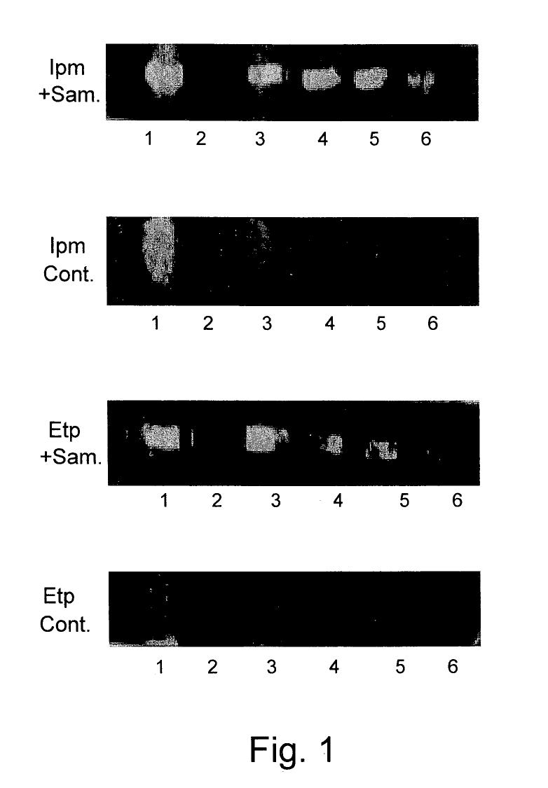

The kit constructed as a twin-slide [as illustrated by FIG. 1] carries an “OCTET” strip impregnated [as in Example 1] with an array of eight beta-lactam antibiotics and 1 non-beta-lactam control [S].

The testing procedure was as described by Examples 1 to 3.

Abbreviations: A—ampicillin, Z—ceftazidime, L—augmentin, T—cefotaxime, S—non-beta-lactam antibiotic, P—imipenem, X— cefuroxime, M—meropenem, R— ceftriaxone.

### DETAILED DESCRIPTION OF THE INVENTION

Over the past three decades, there has been an increasing use of broad spectrum beta lactam antibiotics. Unfortunately, the widespread use of these antibacterial substances has resulted in an alarming increase in the number of resistant strains, especially among clinically important bacteria such as the genera Salmonella, Enterobacteriacae, Pseudomonas and Staphylococcus.

Generally, bacterial resistance to beta lactams occurs primarily through three mechanisms: (i) destruction of the antibiotic by beta-lactamases (ii) decreased penetration due to changes in bacterial outer membrane composition and (iii) alteration in penicillin-binding proteins (PBPs) resulting in interference with beta lactam binding.

In this context, it is noted that beta-lactamase resistance enables microorganisms to outlast antibiotics and is a continuing problem in medical therapy. Increasing resistance to all currently available antibiotics is observed with no new antibiotics with novel mechanisms expected to be developed in the foreseeable future. An extensive and sometimes irresponsible use of beta-lactam antibiotics in clinical and agricultural settings have contributed to the fast emergence and spread of resistant microorganisms, in particular gram-negative pathogens such as Enterobacteriaceae, Pseudomonas aeruginose and Acinetobacter. Extended-spectrum beta-lactamases (ESBL) have evolved as a result of point mutations in beta-lactamase genes, allowing them to hydrolyze a number of antibiotics of the latest generation such as cephalosporins and monobactams.

These resistant strains in general, and an initially unnoticed development of additional resistant strains may jeopardize the treatment and protection of a patient, especially in a clinical environment, since the attending physician may not predict, whether the antibiotic administered will prove effective in the course of the treatment. For this reason, the knowledge about the presence of resistant bacteria is of utmost importance for the decision, which antibiotic is to be used. The clinical standard procedures for identifying pathogens and a potential resistance are tedious and require up to three days before a resistance can be determined. These procedures mostly rely on phenotypic identification using agar diffusion tests, which are cost-effective though, but slow. Also, multiple antibiotics have to be tested in order to identify an ESBL phenotype. Moreover, such a long time-lag between sampling and obtaining the results of the experiments on the basis of which the appropriate antibiotic may be selected does put the patient in danger and may be life-threatening. For this reason, under most circumstances, the patient will receive a broad-spectrum antibiotic, a practice now known to contribute to the further spread of antibiotic resistant strains.

Thus, there is clearly a need in the art for a method which permits both, a rapid and highly reliable determination of a potential resistance of micro-organisms contained in a biological sample, and also an easy processing of a plurality of samples. In addition, due to the high cost pressure in the medical field, performing the method should not be cost-intensive.

The invention presented herein is based on an unexpected observation made accidentally in the course of an unrelated investigation. The inventor noted that a disturbingly increasing proportion of urine samples sent for routine testing were found to carry multidrug resistant bacteria. The inventor then discovered that in such samples all multidrug resistant bacteria can be shown to contain detectable levels of beta-lactamase.

That discovery meant that direct testing for beta-lactamase activity in a sample collected for routine testing can provide “real-time”, essentially on the spot (i.e. without need of incubation or a particular equipment or instrumentation), information on the sensitivity profile of the sample. Routine testing, requiring prolonged incubations for cultivation, isolation and eventual sensitivity tests will yield such information days later. Indeed as shown below, simultaneous detection and profiling of beta-lactam sensitivity can be unequivocally achieved within minutes. It will be realized that here, for the first time, there is a test for spotting, with no delay, the susceptibility profile of a sample, identifying a multidrug resistant infection and for sounding an alarm before it had a chance to spread.

Thus, in a first aspect, the present invention provides a method for the rapid detection of beta-lactam resistant microorganism, specifically, bacteria in a test sample. It should be appreciated that the invention thus optionally further provides susceptibility and resistance profiling of the sample.

According to certain embodiments, the method comprises the steps of: (a) providing an array comprising at least one beta-lactam antibiotic, wherein each of the beta-lactam antibiotics is located in a defined position in the array. The second step (b) involves contacting aliquots of un-cultured test sample with the beta-lactam antibiotics comprised within the array of (a) under conditions allowing enzymatic activity and formation of a detectable product. Finally, step (c) involves “real-time”, direct determination of the presence of hydrolysis product/s of the beta-lactam antibiotics comprised in the array of (a) by suitable means, preferably, with no need for any equipment. A positive determination of hydrolysis products of at least one beta-lactam antibiotic comprised within the array of (a) indicates the existence of a beta-lactam hydrolyzing enzyme in the sample, thereby providing the detection of beta-lactam resistant bacteria in said tested sample. More specifically, the different beta-lactam classes used by the method of the invention may comprise antibiotics of the following beta-lactam classes: (i) beta-lactam carbapenem antibiotics; (ii) beta-lactam penicillin antibiotics; (iii) beta-lactam cephalosporin antibiotics; (iv) beta-lactam monobactam antibiotics; (v) beta-lactam cephamycin antibiotics; and (vi) beta lactamase inhibitor or a combination of at least one beta-lactam antibiotic of the classes defined in any one of (i) to (v) with a beta-lactamase inhibitor.

According to certain specific embodiments, the method of the invention comprises the steps of: (a) providing an array comprising at least one beta-lactam carbapenem antibiotic and optionally at least one beta-lactam antibiotic of at least one other class, wherein each of the beta-lactam antibiotics is located in a defined position in the array. The second step (b) involves contacting aliquots of un-cultured test sample with the beta-lactam antibiotics comprised within the array of (a) under conditions allowing enzymatic activity and formation of a detectable product. Finally, step (c) involves “real-time” direct determination of the presence of hydrolysis product/s of the beta-lactam antibiotics comprised in the array of (a) by suitable means, with no need for any equipment. A positive determination of hydrolysis products of at least one beta-lactam antibiotic comprised within the array of (a) indicates the existence of a bata-lactam hydrolyzing enzyme in the sample, thereby providing the detection of beta-lactam resistant bacteria in said tested sample. It should be noted that according to certain embodiments, resistance of the bacteria in the test sample to the specific beta-lactam antibiotics is conferred by the beta-lactam hydrolyzing enzyme in the sample, specifically, beta-lactamase.

As used herein, the term “beta-lactamase” denotes a protein capable of catalyzing cleavage of a beta-lactamase substrate such as a beta-lactam containing molecule (such as a beta-lactam antibiotic) or derivative thereof.

Beta-lactamases are organized into four molecular classes (A, B, C and D) based on their amino acid sequences. Class A enzymes have a molecular weight of about 29 kDa and preferentially hydrolyze penicillins. Examples of class A enzymes include RTEM and the beta-lactamase of Staphylococcus aureus. Class B enzymes include metalloenzymes that have a broader substrate profile than the other classes of beta-lactamases. Class C enzymes have molecular weights of approximately 39 kDa and include the chromosomal cephalosporinases of gram-negative bacteria, which are responsible for the resistance of gram-negative bacteria to a variety of both traditional and newly designed antibiotics. In addition, class C enzymes also include the lactamase of P99 Enterobacter cloacae, which is responsible for making this Enterobacter species one of the most widely spread bacterial agents in United States hospitals. The class D enzymes are serine hydrolases, which exhibit a unique substrate profile.

As indicated herein above, the method of the invention is intended for directly detecting beta-lactam resistant bacteria in a sample. Therefore, in a first step, an array comprising different beta-lactam antibiotics, specifically, carbapenem antibiotics and optionally beta-lactam antibiotics of other classes, is provided.

The term “beta-lactam” or “beta lactam antibiotics” as used herein refers to any antibiotic agent which contains a beta-lactam ring in its molecular structure.

Beta-lactam antibiotics are a broad group of antibiotics that include different classes such as natural and semi-synthetic penicillins, clavulanic acid, carbapenems, penicillin derivatives (penams), cephalosporins (cephems), cephamycins and monobactams, that is, any antibiotic agent that contains a beta-lactam ring in its molecular structure. They are the most widely-used group of antibiotics. While not true antibiotics, the beta-lactamase inhibitors are often included in this group.

Beta-lactam antibiotics are analogues of D-alanyl-D-alanine the terminal amino acid residues on the precursor NAM/NAG-peptide subunits of the nascent peptidoglycan layer. The structural similarity between beta-lactam antibiotics and D-alanyl-D-alanine prevents the final crosslinking (transpeptidation) of the nascent peptidoglycan layer, disrupting cell wall synthesis.

Under normal circumstances peptidoglycan precursors signal a reorganisation of the bacterial cell wall and, as a consequence, trigger the activation of autolytic cell wall hydrolases. Inhibition of cross-linkage by beta-lactams causes a build-up of peptidoglycan precursors, which triggers the digestion of existing peptidoglycan by autolytic hydrolases without the production of new peptidoglycan. As a result, the bactericidal action of beta-lactam antibiotics is further enhanced.

In one specific embodiment, the array provided in step (a) may comprise: (i) at least one beta-lactam carbapenem antibiotic and optionally at least one beta-lactam antibiotic of at least one other antibiotics class or any combinations thereof. Each of the beta-lactam antibiotics is located in a defined and recorded position in the array. According to this specific embodiment, the different beta-lactam antibiotics of other classes comprised within the array may include: (ii) beta-lactam penicillin antibiotics; (iii) beta-lactam cephalosporin antibiotics; (iv) beta-lactam monobactam antibiotics; (v) beta-lactam cephamycin antibiotics; and (vi) beta lactamase inhibitor or a combination of at least one beta-lactam antibiotic of the classes defined in any one of (i) to (v) with a beta-lactamase inhibitor.

Generally, beta-lactams are classified and grouped according to their core ring structures, where each group may be divided to different categories. The term “penam” is used to describe the core skeleton of a member of a penicillin antibiotic. i.e. a beta-lactam containing a thiazolidine rings. Penicillins contain a beta-lactam ring fused to a 5-membered ring, where one of the atoms in the ring is a sulfur and the ring is fully saturated. Penicillins may include narrow spectrum pinicillins, such as benzathine penicillin, benzylpenicillin (penicillin G), phenoxymethylpenicillin (penicillin V), procaine penicillin and oxacillin. Narrow spectrum penicillinase-resistant penicillins, such as methicillin, dicloxacillin and flucloxacillin. The narrow spectrum beta-lactamase-resistant penicillins may include temocillin. The moderate spectrum penicillins include for example, amoxicillin and ampicillin. The broad spectrum penicillins include the co-amoxiclav (amoxicillin+clavulanic acid). Finally, the penicillin group also includes the extended spectrum penicillins, for example, azlocillin, carbenicillin, ticarcillin, mezlocillin and piperacillin.

Penicillins are sometimes combined with other ingredients called beta-lactamase inhibitors, which protect the penicillin from bacterial enzymes that may destroy it before it can do its work. The drug augmentin, for example used in Example 3, contains a combination of amoxicillin and a beta-lactamase inhibitor, clavulanic acid. Other members of this class include pivampicillin, hetacillin, bacampicillin, metampicillin, talampicillin, epicillin, carbenicillin, carindacillin, ticarcillin, azlocillin, piperacillin, mezlocillin, mecillinam, pivmecillinam, sulbenicillin, clometocillin, procaine benzylpenicillin, azidocillin, penamecillin, propicillin, pheneticillin, cloxacillin and nafcillin.

Beta-lactams containing pyrrolidine rings are named carbapenams. A carbapenam is a beta-lactam compound that is a saturated carbapenem. They exist primarily as biosynthetic intermediates on the way to the carbapenem antibiotics.

Carbapenems have a structure that renders them highly resistant to beta-lactamases and therefore are considered as the broadest spectrum of beta-lactam antibiotics. The carbapenems are structurally very similar to the penicillins, but the sulfur atom in position 1 of the structure has been replaced with a carbon atom, and hence the name of the group, the carbapenems. Carbapenem antibiotics were originally developed from thienamycin, a naturally-derived product of Streptomyces cattleya. The carbapenems group includes: biapenem, doripenem, ertapenem, imipenem, meropenem, panipenem and PZ-601.

Beta-lactams containing 2,3-dihydrothiazole rings are named penems. Penems are similar in structure to carbapenems. However, where penems have a sulfur, carbapenems have another carbon. There are no naturally occurring penems; all of them are synthetically made. An example for penems is faropenem.

Beta-lactams containing 3,6-dihydro-2H-1,3-thiazine rings are named cephems. Cephems are a sub-group of beta-lactam antibiotics and include cephalosporins and cephamycins. The cephalosporins are broad-spectrum, semisynthetic antibiotics, which share a nucleus of 7-aminocephalosporanic acid. First generation cephalosporins, also considered as the moderate spectrum includes cephalexin, cephalothin and cefazolin. Second generation cephalosporins that are considered as having moderate spectrum with anti-Haemophilus activity may include cefaclor, cefuroxime and cefamandole. Second generation cephamycins that exhibit moderate spectrum with anti-anaerobic activity include cefotetan and cefoxitin. Third generation cephalosporins considered as having broad spectrum of activity includes cefotaxime and cefpodoxime.

Finally, the fourth generation cephalosporins considered as broad spectrum with enhanced activity against Gram positive bacteria and beta-lactamase stability include the cefepime and cefpirome. The cephalosporin class may further include: cefadroxil, cefixime, cefprozil, cephalexin, cephalothin, cefuroxime, cefamandole, cefepime and cefpirome.

Cephamycins are very similar to cephalosporins and are sometimes classified as cephalosporins. Like cephalosporins, cephamycins are based upon the cephem nucleus. Cephamycins were originally produced by Streptomyces, but synthetic ones have been produced as well. Cephamycins possess a methoxy group at the 7-alpha position and include: cefoxitin, cefotetan, cefmetazole and flomoxef.

Beta-lactams containing 1,2,3,4-tetrahydropyridine rings are named carbacephems. Carbacephems are synthetically made antibiotics, based on the structure of cephalosporin, a cephem. Carbacephems are similar to cephems but with a carbon substituted for the sulfur. An example of carbacephems is loracarbef.

Monobactams are beta-lactam compounds wherein the beta-lactam ring is alone and not fused to another ring (in contrast to most other beta-lactams, which have two rings). They work only against Gram-negative bacteria. Other examples of monobactams are tigemonam, nocardicin A and tabtoxin.

Beta-lactams containing 3,6-dihydro-2H-1,3-oxazine rings are named oxacephems or clavams. Oxacephems are molecules similar to cephems, but with oxygen substituting for the sulfur. Thus, they are also known as oxapenams. An example for oxapenams is clavulanic acid. They are synthetically made compounds and have not been discovered in nature. Other examples of oxacephems include moxalactam and flomoxef.

Another group of beta-lactam antibiotics is the beta-lactamase inhibitors, for example, clavulanic acid. Although they exhibit negligible antimicrobial activity, they contain the beta-lactam ring. Their sole purpose is to prevent the inactivation of beta-lactam antibiotics by binding the beta-lactamases, and, as such, they are co-administered with beta-lactam antibiotics. Beta-lactamase inhibitors in clinical use include clavulanic acid and its potassium salt (usually combined with amoxicillin or ticarcillin), sulbactam and tazobactam. As shown in Example 3 of the invention, the use of clavulanic acid with amoxicillin exemplifies a combination of at least one beta-lactam antibiotic of the group of carbapenems, penicillins, cephalosporins, cephamycins and monobactams, with a beta-lactamase inhibitor.

According to one embodiment, the array used by the methods and kits of the invention may comprise at least one carbapenem antibiotic selected from the group of imipenem, meropenem, ertapenem, doripenem, biapenem and PZ-601. In certain embodiments, the array may comprise at least one, at least two, at least three, at least four, at least five, or at least six carbapenem antibiotic substrates selected from the group consisting of imipenem, meropenem, ertapenem, doripenem, biapenem and PZ-601. As shown by Example 1, the array of the invention may comprise two different carbapenem antibiotic substrates, for example, ertapenem and imipenem.

Still further, the array of the invention may comprise at least one carbapenem and at least one antibiotic substrate from at least one other beta lactam antibiotics group.

Thus, according to one embodiment, the array may comprise at least one carbapenem such as imipenem, meropenem, ertapenem, doripenem, biapenem and PZ-601 and at least one cephalosporin antibiotic such as cefotetan, cefpodoxime, cefaclor, cefadroxil, cefazolin, cefixime, cefprozil, ceftazidime, cefuroxime, cephalexin, cephalothin, cefuroxime, cefamandole, ceftriaxone, cefotaxime, cefepime and cefpirome. In certain embodiments, the array may comprise at least one, at least two, at least three, at least four, at least five, or at least six carbapenem antibiotic substrates and at least one, at least two, at least three, at least four, at least five, at least six, at least seven, at least eight, at least nine, at least ten, at least eleven, at least twelve, at least thirteen, at least fourteen, at least fifteen, at least sixteen and at least seventeen cephalosporin antibiotic substrates.

According to another embodiment, the array may comprise at least one carbapenem selected from the group of imipenem, meropenem, ertapenem, doripenem, biapenem and PZ-601 and at least one beta lactam penicillin antibiotic such as amoxicillin, ampicillin, pivampicillin, hetacillin, bacampicillin, metampicillin, talampicillin, epicillin, carbenicillin, carindacillin, ticarcillin, temocillin, azlocillin, piperacillin, mezlocillin, mecillinam, pivmecillinam, sulbenicillin, clometocillin, benzathine benzylpenicillin, procaine benzylpenicillin, azidocillin, penamecillin, propicillin, benzathine phenoxymethylpenicillin, pheneticillin, cloxacillin, dicloxacillin, flucloxacillin, oxacillin, meticillin and nafcillin. In certain embodiments, the array may comprise at least one, at least two, at least three, at least four, at least five, or at least six carbapenem antibiotic substrates and at least one, at least two, at least three, at least four, at least five, at least six, at least seven, at least eight, at least nine, at least ten, at least eleven, at least twelve, at least thirteen, at least fourteen, at least fifteen, at least sixteen, at least seventeen, at least eighteen, at least nineteen, at least twenty, at least twenty one, at least twenty two, at least twenty three at least twenty four, at least twenty five, at least twenty six, at least twenty seven, at least twenty eight, at least twenty nine, at least thirty, at least thirty one, at least thirty two and at least thirty three penicillin antibiotic substrates.

According to another embodiment, the array may comprise at least one carbapenem selected from the group of imipenem, meropenem, ertapenem, doripenem, biapenem and PZ-601 and at least one cephamycin antibiotic selected from the group of cefoxitin, cefotetan, cefmetazole and flomoxef. In certain embodiments, the array may comprise at least one, at least two, at least three, at least four, at least five, or at least six carbapenem antibiotic substrates and at least one, at least two, at least three or at least four cephamycin antibiotic substrates.

According to yet another embodiment, the array may comprise at least one carbapenem selected from the group of imipenem, meropenem, ertapenem, doripenem, biapenem and PZ-601 and at least one monobactam antibiotic selected from the group of aztreonam, tigemonam, nocardicin A and tabtoxin. In certain embodiments, the array may comprise at least one, at least two, at least three, at least four, at least five, or at least six carbapenem antibiotic substrates and at least one, at least two, at least three or at least four monobactam antibiotic substrates.

According to yet another embodiment, the array may comprise at least one carbapenem selected from the group of imipenem, meropenem, ertapenem, doripenem, biapenem and PZ-601 and at least one beta lactamase inhibitor from the group of clavulanic acid and its potassium salt, sulbactam and tazobactam. In certain embodiments, the array may comprise at least one, at least two, at least three, at least four, at least five, or at least six carbapenem antibiotic substrates and at least one, at least two or at least three beta lactamase inhibitors.

In still more specific embodiments, the array may comprise at least one carbapenem selected from the group of imipenem, meropenem, ertapenem, doripenem, biapenem and PZ-601, at least one cephalosporin antibiotic such as cefotetan, cefpodoxime, cefaclor, cefadroxil, cefazolin, cefixime, cefprozil, ceftazidime, cefuroxime, cephalexin, cephalothin, cefuroxime, cefamandole, ceftriaxone, cefotaxime, cefepime and cefpirome, and at least one penicillin antibiotic selected from the group of amoxicillin, ampicillin, pivampicillin, hetacillin, bacampicillin, metampicillin, talampicillin, epicillin, carbenicillin, carindacillin, ticarcillin, temocillin, azlocillin, piperacillin, mezlocillin, mecillinam, pivmecillinam, sulbenicillin, clometocillin, benzathine benzylpenicillin, procaine benzylpenicillin, azidocillin, penamecillin, propicillin, benzathine phenoxymethylpenicillin, pheneticillin, cloxacillin, dicloxacillin, flucloxacillin, oxacillin, meticillin and nafcillin. In certain embodiments, the array may comprise at least one, at least two, at least three, at least four, at least five, or at least six carbapenem antibiotic substrates, at least one, at least two, at least three, at least four, at least five, at least six, at least seven, at least eight, at least nine, at least ten, at least eleven, at least twelve, at least thirteen, at least fourteen, at least fifteen, at least sixteen and at least seventeen cephalosporin antibiotic substrates, and at least one, at least two, at least three, at least four, at least five, at least six, at least seven, at least eight, at least nine, at least ten, at least eleven, at least twelve, at least thirteen, at least fourteen, at least fifteen, at least sixteen, at least seventeen, at least eighteen, at least nineteen, at least twenty, at least twenty one, at least twenty two, at least twenty three at least twenty four, at least twenty five, at least twenty six, at least twenty seven, at least twenty eight, at least twenty nine, at least thirty, at least thirty one, at least thirty two and at least thirty three penicillin antibiotic substrates. As shown in Example 1, ampicillin, ceftazidime and either imipenem or meropenem were used, demonstrating an array comprising antibiotics of three beta-lactam classes, the carbapenems, the penicillins and the cephalosporins.

In still more specific embodiments, the array may comprise at least one carbapenem selected from the group of imipenem, meropenem, ertapenem, doripenem, biapenem and PZ-601, at least one cephalosporin antibiotic selected from the group of cefotetan, cefpodoxime, cefaclor, cefadroxil, cefazolin, cefixime, cefprozil, ceftazidime, cefuroxime, cephalexin, cephalothin, cefuroxime, cefamandole, ceftriaxone, cefotaxime, cefepime and cefpirome, and at least one cephamycin antibiotic selected from the group of cefoxitin, cefotetan, cefmetazole and flomoxef. In certain embodiments, the array may comprise at least one, at least two, at least three, at least four, at least five, or at least six carbapenem antibiotic substrates, at least one, at least two, at least three, at least four, at least five, at least six, at least seven, at least eight, at least nine, at least ten, at least eleven, at least twelve, at least thirteen, at least fourteen, at least fifteen, at least sixteen and at least seventeen cephalosporin antibiotic substrates, and at least one, at least two, at least three or at least four cephamycin antibiotic substrates.

In still more specific embodiments, the array may comprise at least one carbapenem selected from the group of imipenem, meropenem, ertapenem, doripenem, biapenem and PZ-601, at least one cephalosporin antibiotic selected from the group of cefotetan, cefpodoxime, cefaclor, cefadroxil, cefazolin, cefixime, cefprozil, ceftazidime, cefuroxime, cephalexin, cephalothin, cefuroxime, cefamandole, ceftriaxone, cefotaxime, cefepime and cefpirome, and at least one monobactam antibiotic selected from the group of aztreonam, tigemonam, nocardicin A and tabtoxin. In certain embodiments, the array may comprise at least one, at least two, at least three, at least four, at least five, or at least six carbapenem antibiotic substrates, at least one, at least two, at least three, at least four, at least five, at least six, at least seven, at least eight, at least nine, at least ten, at least eleven, at least twelve, at least thirteen, at least fourteen, at least fifteen, at least sixteen and at least seventeen cephalosporin antibiotic substrates, and at least one, at least two, at least three or at least four monobactam antibiotic substrates.

In still more specific embodiments, the array may comprise at least one carbapenem selected from the group of imipenem, meropenem, ertapenem, doripenem, biapenem and PZ-601, at least one cephalosporin antibiotic such as cefotetan, cefpodoxime, cefaclor, cefadroxil, cefazolin, cefixime, cefprozil, ceftazidime, cefuroxime, cephalexin, cephalothin, cefuroxime, cefamandole, ceftriaxone, cefotaxime, cefepime and cefpirome, and at least one beta lactamase inhibitor from the group of clavulanic acid and its potassium salt, sulbactam and tazobactam. In certain embodiments, the array may comprise at least one, at least two, at least three, at least four, at least five, or at least six carbapenem antibiotic substrates, at least one, at least two, at least three, at least four, at least five, at least six, at least seven, at least eight, at least nine, at least ten, at least eleven, at least twelve, at least thirteen, at least fourteen, at least fifteen, at least sixteen and at least seventeen cephalosporin antibiotic substrates, and at least one, at least two or at least three beta lactamase inhibitors.

According to another embodiment, the array may comprise at least one carbapenem selected from the group of imipenem, meropenem, ertapenem, doripenem, biapenem and PZ-601, at least one beta lactam penicillin antibiotic selected from the group of amoxicillin, ampicillin, pivampicillin, hetacillin, bacampicillin, metampicillin, talampicillin, epicillin, carbenicillin, carindacillin, ticarcillin, temocillin, azlocillin, piperacillin, mezlocillin, mecillinam, pivmecillinam, sulbenicillin, clometocillin, benzathine benzylpenicillin, procaine benzylpenicillin, azidocillin, penamecillin, propicillin, benzathine phenoxymethylpenicillin, pheneticillin, cloxacillin, dicloxacillin, flucloxacillin, oxacillin, meticillin and nafcillin and at least one cephamycin antibiotic selected from the group of cefoxitin, cefotetan, cefmetazole and flomoxef. In certain embodiments, the array may comprise at least one, at least two, at least three, at least four, at least five, or at least six carbapenem antibiotic substrates, at least one, at least two, at least three, at least four, at least five, at least six, at least seven, at least eight, at least nine, at least ten, at least eleven, at least twelve, at least thirteen, at least fourteen, at least fifteen, at least sixteen, at least seventeen, at least eighteen, at least nineteen, at least twenty, at least twenty one, at least twenty two, at least twenty three at least twenty four, at least twenty five, at least twenty six, at least twenty seven, at least twenty eight, at least twenty nine, at least thirty, at least thirty one, at least thirty two and at least thirty three penicillin antibiotic substrates and at least one, at least two, at least three or at least four cephamycin antibiotic substrates.

According to another embodiment, the array may comprise at least one carbapenem selected from the group of imipenem, meropenem, ertapenem, doripenem, biapenem and PZ-601, at least one beta lactam penicillin antibiotic selected from the group of amoxicillin, ampicillin, pivampicillin, hetacillin, bacampicillin, metampicillin, talampicillin, epicillin, carbenicillin, carindacillin, ticarcillin, temocillin, azlocillin, piperacillin, mezlocillin, mecillinam, pivmecillinam, sulbenicillin, clometocillin, benzathine benzylpenicillin, procaine benzylpenicillin, azidocillin, penamecillin, propicillin, benzathine phenoxymethylpenicillin, pheneticillin, cloxacillin, dicloxacillin, flucloxacillin, oxacillin, meticillin and nafcillin and at least one monobactam antibiotic selected from the group of aztreonam, tigemonam, nocardicin A and tabtoxin. In certain embodiments, the array may comprise at least one, at least two, at least three, at least four, at least five, or at least six carbapenem antibiotic substrates, at least one, at least two, at least three, at least four, at least five, at least six, at least seven, at least eight, at least nine, at least ten, at least eleven, at least twelve, at least thirteen, at least fourteen, at least fifteen, at least sixteen, at least seventeen, at least eighteen, at least nineteen, at least twenty, at least twenty one, at least twenty two, at least twenty three at least twenty four, at least twenty five, at least twenty six, at least twenty seven, at least twenty eight, at least twenty nine, at least thirty, at least thirty one, at least thirty two and at least thirty three penicillin antibiotic substrates and at least one, at least two, at least three or at least four monobactam antibiotic substrates.

According to another embodiment, the array may comprise at least one carbapenem selected from the group of imipenem, meropenem, ertapenem, doripenem, biapenem and PZ-601, at least one beta lactam penicillin antibiotic selected from the group of amoxicillin, ampicillin, pivampicillin, hetacillin, bacampicillin, metampicillin, talampicillin, epicillin, carbenicillin, carindacillin, ticarcillin, temocillin, azlocillin, piperacillin, mezlocillin, mecillinam, pivmecillinam, sulbenicillin, clometocillin, benzathine benzylpenicillin, procaine benzylpenicillin, azidocillin, penamecillin, propicillin, benzathine phenoxymethylpenicillin, pheneticillin, cloxacillin, dicloxacillin, flucloxacillin, oxacillin, meticillin and nafcillin and at least one beta lactamase inhibitor from the group of clavulanic acid and its potassium salt, sulbactam and tazobactam. In certain embodiments, the array may comprise at least one, at least two, at least three, at least four, at least five, or at least six carbapenem antibiotic substrates, at least one, at least two, at least three, at least four, at least five, at least six, at least seven, at least eight, at least nine, at least ten, at least eleven, at least twelve, at least thirteen, at least fourteen, at least fifteen, at least sixteen, at least seventeen, at least eighteen, at least nineteen, at least twenty, at least twenty one, at least twenty two, at least twenty three at least twenty four, at least twenty five, at least twenty six, at least twenty seven, at least twenty eight, at least twenty nine, at least thirty, at least thirty one, at least thirty two and at least thirty three penicillin antibiotic substrates and at least one, at least two or at least three beta lactamase inhibitors.

According to another embodiment, the array may comprise at least one carbapenem selected from the group of imipenem, meropenem, ertapenem, doripenem, biapenem and PZ-601, at least one cephamycin antibiotic selected from the group of cefoxitin, cefotetan, cefmetazole and flomoxef, at least one monobactam antibiotic selected from the group of aztreonam, tigemonam, nocardicin A and tabtoxin, at least one beta lactam penicillin antibiotic selected from the group of amoxicillin, ampicillin, pivampicillin, hetacillin, bacampicillin, metampicillin, talampicillin, epicillin, carbenicillin, carindacillin, ticarcillin, temocillin, azlocillin, piperacillin, mezlocillin, mecillinam, pivmecillinam, sulbenicillin, clometocillin, benzathine benzylpenicillin, procaine benzylpenicillin, azidocillin, penamecillin, propicillin, benzathine phenoxymethylpenicillin, pheneticillin, cloxacillin, dicloxacillin, flucloxacillin, oxacillin, meticillin and nafcillin, at least one beta lactamase inhibitor from the group of clavulanic acid and its potassium salt, sulbactam and tazobactam and at least one cephalosporin antibiotic selected from the group of cefotetan, cefpodoxime, cefaclor, cefadroxil, cefazolin, cefixime, cefprozil, ceftazidime, cefuroxime, cephalexin, cephalothin, cefuroxime, cefamandole, ceftriaxone, cefotaxime, cefepime and cefpirome.

In yet another embodiment, the array may comprise at least one beta lactam antibiotic of at least one class comprising any one of: at least one carbapenem selected from the group of imipenem, meropenem, ertapenem, doripenem, biapenem and PZ-601; at least one cephamycin antibiotic selected from the group of cefoxitin, cefotetan, cefmetazole and flomoxef; at least one monobactam antibiotic selected from the group of aztreonam, tigemonam, nocardicin A and tabtoxin; at least one beta lactam penicillin antibiotic selected from the group of amoxicillin, ampicillin, pivampicillin, hetacillin, bacampicillin, metampicillin, talampicillin, epicillin, carbenicillin, carindacillin, ticarcillin, temocillin, azlocillin, piperacillin, mezlocillin, mecillinam, pivmecillinam, sulbenicillin, clometocillin, benzathine benzylpenicillin, procaine benzylpenicillin, azidocillin, penamecillin, propicillin, benzathine phenoxymethylpenicillin, pheneticillin, cloxacillin, dicloxacillin, flucloxacillin, oxacillin, meticillin and nafcillin; at least one beta lactamase inhibitor from the group of clavulanic acid and its potassium salt, sulbactam and tazobactam; and at least one cephalosporin antibiotic selected from the group of cefotetan, cefpodoxime, cefaclor, cefadroxil, cefazolin, cefixime, cefprozil, ceftazidime, cefuroxime, cephalexin, cephalothin, cefuroxime, cefamandole, ceftriaxone, cefotaxime, cefepime and cefpirome.

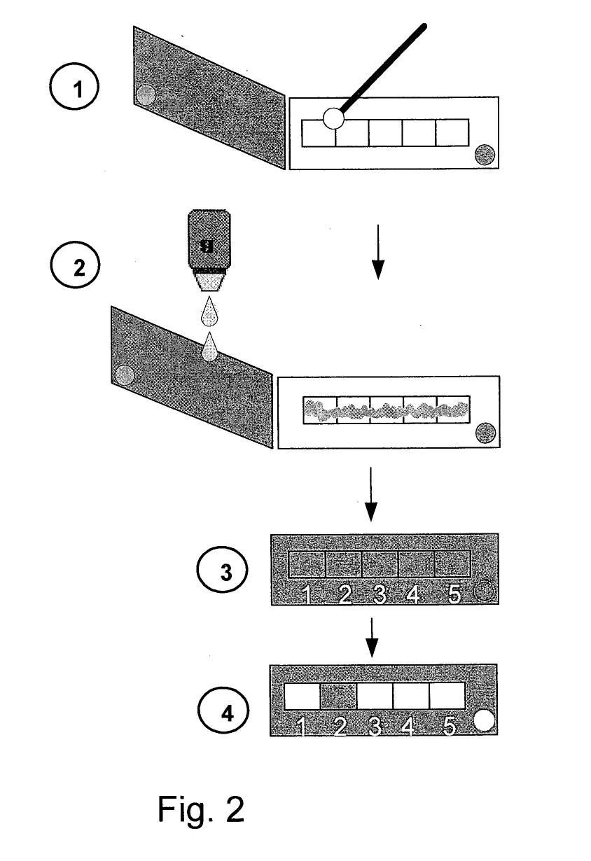

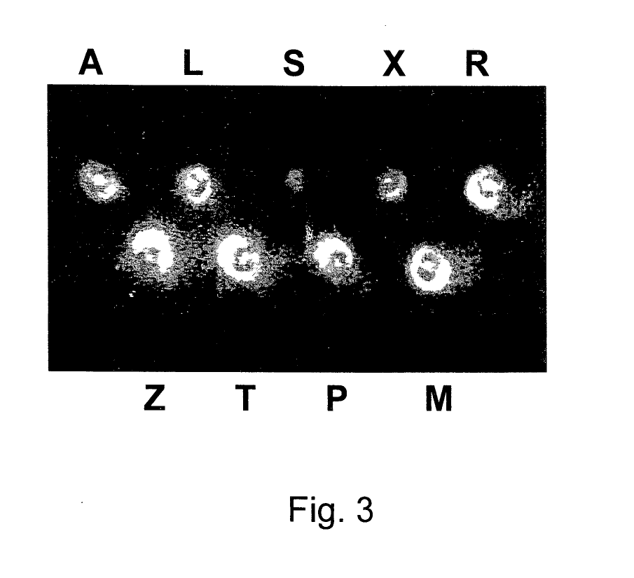

As indicated above, the different beta-lactam antibiotic substrates provided with the methods and kits of the invention are comprised within an array. The term “array” refers to an “addressed” spatial arrangement of beta-lactam antibiotics. Each “position” or “address” of the array (a specific spatial region) is a predetermined specific spatial region containing a known beta-lactam antibiotics attached, embedded, linked, connected, placed, glued or fused thereto. For example, an array may be a plurality of vessels (test tubes), plates (or even different predetermined locations in one plate), micro-wells in a micro-plate each containing a different beta-lactam antibiotics. As shown by the following examples, the array may be a filter paper strip or a slide containing filter paper segments each impregnated with a beta-lactam antibiotic substrate. An array may also be any solid support holding in distinct regions (dots, lines, columns) different and known inhibitory agents or antibodies. The array preferably includes built-in appropriate controls, for example, regions without the sample, regions with non-beta-lactam antibiotics, regions without any drug, regions without either, namely with solvent and reagents alone (negative control). According to certain embodiments the array may include a positive control, for example a duplicate of one of the beta-lactams included in the array, said duplicate placed in a spot facing a spot presenting a calibrated amount of a beta-lactamase known to hydrolyze said beta-lactam in said embodiment. The positive control will serve as an indicator confirming that no change in the test spots within the prescribed time interval means that the results of the test are negative. It will be noted that the positive control will be of particular value providing a “time-frame” indicator or an internal “clock” as demonstrated by the illustrative scheme in FIG. 2. Solid support used for the array of the invention will be described in more detail herein after, in connection with the kits provided by the invention.

As indicated herein above, the different beta-lactam antibiotics are each attached, embedded, linked, connected, placed, glued or fused to the array in a defined predetermined and recorded position, thereby facilitating a clear and direct identification of the hydrolyzed beta-lactam antibiotics, indicating to which antibiotics the bacteria in the sample are resistant.

According to one specific embodiment, detection of the hydrolysis products of a beta-lactam antibiotic located in a defined and recorded position in the array indicates the identity of the beta-lactam antibiotics hydrolyzed by resistant bacteria in the sample, thereby providing susceptibility and resistance profiling of the test sample.

Thus, by using an array comprising different beta-lactam antibiotics, the method of the invention provides simple and direct tool for susceptibility and resistance profiling of a specimen. Therefore, the present invention provide a clear and direct indication regarding the potential of a given bata-lactam antibiotic to be effective in a certain specimen taken from a specific individual.

Still further, it should be appreciated that according to certain embodiments, the use of different beta-lactam antibiotics representing different groups, and particularly the use of the broad spectrum beta-lactam carbapenems and optionally a further beta-lactam antibiotic of at least one of penicillin, cephalosporin and monobactams classes, allows detecting the resistance of various species of gram-positive and gram-negative bacteria, even in a mixed population thereof.

According to certain embodiments, resistance to at least one beta-lactam antibiotics of at least two of carbapenem, penicillin, cephalosporin and monobactam classes may indicate the presence of multidrug resistant bacteria in the tested sample.

Moreover, the modular method of the invention allows the detection of bacteria resistant to different beta-lactam antibiotics. Thus, by using different antibiotics of different classes in the array provided by the methods and kits described herein, the invention demonstrates, as exemplified in Example 2, the high specificity and sensitivity of detecting multidrug resistant bacteria in a sample.

Therefore, in a second aspect, the invention relates to a method for the rapid detection of the presence of multidrug resistant (MDR) bacteria in a test sample. According to this aspect, the method of the invention comprises the steps of:

(a) providing an array comprising at least one beta-lactam antibiotic of at least two different beta-lactam antibiotic classes. It should be noted that each of the beta-lactam antibiotics is located in a defined position in the array. The second step (b), involves contacting aliquots of the un-cultured test sample with the beta-lactam antibiotics comprised in the array of (a) under conditions allowing enzymatic activity and formation of a detectable product. In the subsequent step (c), the presence of hydrolysis product/s of the beta-lactam antibiotics comprised in the array of (a) is directly determined by suitable means. A positive determination of hydrolysis products of beta-lactam antibiotics from at least two of the beta-lactam antibiotic classes located in the array of (a) indicates the presence of a multi-drug resistant bacteria in the tested sample.

In certain embodiments, the method of detecting MDR bacteria in a sample according to the invention comprises the steps of: (a) providing an array comprising at least one beta-lactam carbapenem antibiotics and at least one beta-lactam antibiotic of at least one other class. It should be noted that each of the beta-lactam antibiotics is located in a defined position in the array. The second step (b), involves contacting aliquots of the un-cultured test sample with the beta-lactam antibiotics comprised in the array of (a) under conditions allowing enzymatic activity and formation of a detectable product. In the subsequent step (c), the presence of hydrolysis product/s of the beta-lactam antibiotics comprised in the array of (a) is directly determined by suitable means. A positive determination of hydrolysis products of beta-lactam antibiotics from at least two of the beta-lactam antibiotic classes located in the array of (a) indicates the presence of a multi-drug resistant bacteria in the tested sample.

In a particular embodiment of this aspect, the array provided by step (a) may comprise: (i) at least one beta-lactam carbapenem antibiotic and at least one beta-lactam antibiotic of at least one other class or any combinations thereof. The beta-lactam classes may include: (ii) beta-lactam penicillin antibiotics; (iii) beta-lactam cephalosporin antibiotics; (iv) beta-lactam monobactam antibiotics; (v) beta-lactam cephamycin antibiotics; and (vi) beta lactamase inhibitor or a combination of at least one beta-lactam antibiotic of the classes defined in any one of (i) to (v) with a beta-lactamase inhibitor. It should be noted that each of the beta-lactam antibiotics is located in a defined position in the array.

According to certain embodiments, resistance to at least one beta-lactam antibiotics of at least two of carbapenem, penicillin, cephalosporin and monobactam classes indicates the presence of multi-drug resistant (MDR) bacteria in the tested sample. It should be noted that all combinations of different beta lactam antibiotics of different classes described herein above apply to all methods and kits of the invention. As demonstrated by Table 1, samples presenting resistance to antibiotics of both cephalosporin and penicillin classes were defined by the invention as MDR.

The methods of the invention provide detection of beta-lactam resistant microorganism, specifically, bacteria, in a sample. It should be noted that the term “bacteria” is used in its broadest sense and includes Gram negative aerobic bacteria, Gram positive aerobic bacteria, Gram negative microaerophillic bacteria, Gram positive microaerophillic bacteria, Gram negative facultative anaerobic bacteria, Gram positive facultative anaerobic bacteria, Gram negative anaerobic bacteria, Gram positive anaerobic bacteria, Gram positive asporogenic bacteria and Actinomycetes. More specifically it should be appreciated that the methods and kits of the invention are particularly applicable for directly detecting resistant Enterobacteriaceae.

As indicated above, the second step of the methods of the invention involves contacting aliquots of a sample with an array comprising different beta-lactam antibiotics. The terms “sample”, “test sample” and “specimen” are used interchangeably in the present specification and claims and are used in its broadest sense. They are meant to include both biological and environmental samples and may include an exemplar of synthetic origin. This term refers to any media that may contain the infection causing bacteria and may include body fluids (urine, blood, milk, cerebrospinal fluid, rinse fluid obtained from wash of body cavities, phlegm, pus), swabs taken from suspected body regions (throat, vagina, ear, eye, skin, sores), food products (both solids and fluids) and swabs taken from medicinal instruments, apparatus, materials).

Biological samples may be provided from animal, including human, fluid, solid (e.g., stool) or tissue, as well as liquid and solid food and feed products and ingredients such as dairy items, vegetables, meat and meat by-products, and waste. Biological samples and specimens may be obtained from all of the various families of domestic animals, as well as feral or wild animals, including, but not limited to, such animals as ungulates, bear, fish, lagamorphs, rodents, etc. Environmental samples include environmental material such as surface matter, soil, water, air and industrial samples, as well as samples obtained from food and dairy processing instruments, apparatus, equipment, utensils, disposable and non-disposable items. These examples are not to be construed as limiting the sample types applicable to the present invention. The sample may be any media that may contain the infection causing bacteria. Typically swabs and samples or specimens that are a priori not liquid are contacted with a liquid media which is contacted with the array.

As disclosed, “conditions allowing enzymatic activity” may include appropriate amount (concentration of beta-lactam antibiotics as a substrate), temperature, reaction time, pH, volume and addition of necessary reaction reagents etc.

More specifically, it should be noted that the incubation of the samples according to the method of the invention may be carried out in a temperature of between about 20° C. to about 50° C., more specifically between about 21° C. to about 49° C., more specifically between about 22° C. to about 48° C., more specifically between about 23° C. to about 47° C., more specifically between about 24° C. to about 46° C., more specifically between about 25° C. to about 44° C., more specifically between about 27° C. to about 43° C., more specifically between about 28° C. to about 42° C., more specifically between about 29° C. to about 41.5° C. and most specifically between 30° C. to about 41° C. In specific embodiments, the incubation of the samples according to the method of the invention may be carried out in a temperature of any one of 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 43° C., 44° C., 45° C., 46° C., 47° C., 48° C., 49° C., and 50° C. For instance, Example 1 demonstrates the incubation of the samples in the temperature range of 30° C. to 40° C., Example 2 demonstrates the incubation of the samples in the temperature range of 33° C. to 38° C. and Example 3 demonstrates the incubation of the samples in the temperature of 38° C.

It should be emphasized that the methods and kits of the invention provide rapid “real-time” results within few minutes. According to certain embodiments, the incubation period of the samples according to the methods of the invention may range between about 60 minutes to about 0.5 minute, more specifically between about 30 minutes to about 1 minute, more specifically between about 20 minutes to about 2 minutes, more specifically between about 15 minutes to about 2 minutes, more specifically between about 10 minutes to about 2 minutes, more specifically between about 5 minutes to about 2 minutes. In specific embodiments, the incubation period required for enzymatic reaction may be any one of 1 minute, 2 minutes, 3 minutes, 4 minutes, 5 minutes, 6 minutes, 3 minutes, 2 minutes, 3 minutes, 2 minutes, 3 minutes, 2 minutes, 3 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 21 minutes, 22 minutes, 23 minutes, 24 minutes, 25 minutes, 26 minutes, 27 minutes, 28 minutes, 29 minutes and 30 minutes. For example, in Example 2, the incubation period of the samples is 5 to 15 minutes, and in Example 1, the incubation period of the samples ranges between 5 to 10 minutes.

It is to be appreciated that in some embodiments, the concentration of the beta-lactam antibiotic substrates used in the invention range between about 0.01 mg/mL to about 100 mg/mL, more specifically between about 0.1 mg/mL to about 60 mg/mL, more specifically between about 0.1 mg/mL to about 50 mg/mL, more specifically between about 0.1 mg/mL to about 45 mg/mL, more specifically between about 0.1 mg/mL to about 40 mg/mL, more specifically between about 0.1 mg/mL to about 35 mg/mL, more specifically between about 0.1 mg/mL to about 34 mg/mL, more specifically between about 0.1 mg/mL to about 33 mg/mL, more specifically between about 0.1 mg/mL to about 32 mg/mL, more specifically between about 0.1 mg/mL to about 31 mg/mL and most specifically between about 0.1 mg/mL to about 30 mg/mL. More particularly, the beta-lactamase antibiotic substrates used by the methods and kits of the invention may be used in a concentration of any one of 0.1 mg/mL, 1 mg/mL, 2 mg/mL, 3 mg/mL, 4 mg/mL, 5 mg/mL, 6 mg/mL, 7 mg/mL, 8 mg/mL, 9 mg/mL, 10 mg/mL, 11 mg/mL, 12 mg/mL, 13 mg/mL, 14 mg/mL, 15 mg/mL, 16 mg/mL, 17 mg/mL, 18 mg/mL, 19 mg/mL, 20 mg/mL, 21 mg/mL, 22 mg/mL, 23 mg/mL, 24 mg/mL, 25 mg/mL, 26 mg/mL, 27 mg/mL, 28 mg/mL, 29 mg/mL, 30 mg/mL, 31 mg/mL, 32 mg/mL, 33 mg/mL, 34 mg/mL, 35 mg/mL, 36 mg/mL, 37 mg/mL, 38 mg/mL, 39 mg/mL, 40 mg/mL, 41 mg/mL, 42 mg/mL, 43 mg/mL 44 mg/mL, 45 mg/mL, 50 mg/mL, 60 mg/mL, 70 mg/mL, 80 mg/m, 90 mg/mL and 100 mg/mL. For example, as show in Example 2, imipenem and ertapenem were used in the concentrations of 30, 0, 20, 15, 10 and 5.0 mg/mL.

In some embodiments, the volume of the beta-lactamase antibiotic substrates used in the invention may range between about 0.1 μL to about 1000 μL, more specifically between about 1 μL to about 500 μL, more specifically between about 5 μL to about 100 μL and more specifically between about 10 μL to about 50 pt. In specific embodiments, the volume of the beta-lactamase antibiotic substrates used in the invention may be any one of 1 μL, 2 μL, 3 μL, 4 μL, 5 μL, 6 μL, 7 μL, 8 μL, 9 μL, 10 μL, 11 μL, 12 μL, 13 μL, 14 μL, 15 μL, 16 μL, 17 μL, 18 μL, 19 μL, 20 μL, 21 μL, 22 μL, 23 μL, 24 μL, 25 μL, 26 μL, 27 μL, 28 μL, 29 μL, 30 μL, 31 μL, 32 μL, 33 μL, 34 μL, 35 μL, 36 μL, 37 μL, 38 μL, 39 μL, 40 μL, 41 μL, 42 μL, 43 μL, 44 μL, 45 μL, 46 μL, 47 μL, 48 μL, 49 μL, 50 μL, 60 μL, 70 μL, 80 μL, 90 μL, 100 μL, 200 μL, 300 μL, 400 μL, 500 μL, 600 μL, 700 μL, 800 μL, 900 μL and 1000 μL.

It is to be appreciated that the quantities of antibiotic substrates used in the arrays provided by the kits and methods of the invention may range between about 0.01 μg to about 10 mg, more specifically between about 0.05 μg to about 5 mg, more specifically between about 0.1 μg to about 2500 μg, more specifically between about 1.0 μg to about 2200 μg, more specifically between about 10 μg to about 2000 μg, more specifically between about 20 μg to about 1700 μg, more specifically between about 30 μg to about 1600 μg, more specifically between about 40 μg to about 1500 μg, more specifically between about 50 μg to about 1400 μg, more specifically between about 100 μg to about 1300 μg, more specifically between about 150 μg to about 1200 μg, more specifically between about 200 μg to about 1100 μg, more specifically between about 200 μg to about 1000 μg and most specifically between about 150 μg to about 900 μg, as demonstrated in Example 1. According to a specific embodiment the quantities of antibiotic substrates used in the arrays of the invention may be any one of 1, 2, 3, 4, 5, 6, 7, 8, 9, 10, 15, 20, 25, 30, 35, 40 45, 50, 55, 60, 65, 70, 75, 80, 85, 90, 95, 100, 110, 120, 130, 140, 150, 160, 170, 180, 190, 200, 250, 300, 350, 400, 45, 500, 550, 600, 650, 700, 750, 800, 850, 900, 950, 1000 μg.

In some embodiments, the pH of the Activator solution used in the invention may range between about pH 5.5 to about pH 7.5, more specifically, between about pH 5.6 to about pH 7.4, more specifically between about pH 5.7 to about pH 7.3, more specifically between about pH 5.8 to about pH 7.2, more specifically between about pH 5.9 to about pH 7.1, more specifically between about pH 6.0 to about pH 7.0, more specifically between about pH 6.1 to about pH 6.9, more specifically between about pH 6.2 to about pH 6.8, more specifically between about pH 6.3 to about pH 6.7, more specifically between about pH 6.4 to about pH 6.6. In specific embodiments, the pH of the Activator solution used in the invention may be any one of pH 5.5, pH 5.6, pH 5.7, pH 5.8, pH 5.9, pH 6.0 pH 6.1, pH 6.2, pH 6.3, pH 6.4, pH 6.6, pH 6.7, pH 6.8, pH 6.9, pH 7.0, pH 7.1, pH 7.2, pH 7.3, pH 7.4 and pH 7.5. Most specifically, the pH of the Activator solution used in the invention is pH 6.5.

One skilled in the art will recognize that the order of the steps described in the disclosed method may be modified without departing from the spirit and intended scope of the invention. Thus, in some embodiments, the different beta-lactam antibiotic substrates, the Assay reagent and Activator solution are added to a paper strip or to any other solid support in any order. Subsequently, said solid support being contacted and incubated with a slide or any other solid support containing the sample, as is exemplified in Example 1 and 2. In other embodiments, the test sample is contacted with a solid support containing different beta-lactam antibiotic substrates. Subsequently, the sample-substrate are contacted and incubated with another solid support, containing the Assay reagent and Activator solution, as shown in Example 3.

The third step of the methods of the invention includes direct and “real-time” determination of production of a detectable hydrolysis product. Reference to “determining”, as used herein, includes estimating, quantifying, calculating or otherwise deriving by measuring an end point indication that may be for example, the appearance of a detectable product, any detectable change in the substrate levels or any change in the rate of the appearance of the product or the disappearance of the substrate. The term “directly determining” refers to a determination without conventional steps routinely demanded such as incubation for cultivation and/or isolation and/or sensitivity determination and indeed for any purpose whatsoever. Thus, the sample that can be used in the kits and methods of the invention is an “un-cultured” sample that was not incubated for bacterial growth before use. Moreover, direct determination refers specifically to determination without the need of using any equipment, facilities or particular apparatus.

The term “detectable” as used herein refers to the presence of a detectable signal generated from a detectable chemical reaction that is immediately detectable by observation, instrumentation, or film. The term “detectable product” as used herein refers to a product causing an occurrence of, or a change in, a signal that is directly or indirectly detectable (observable) either by visual observation or by instrumentation. Typically, the detectable product is detectable in an optical property (“optically detectable”) as reflected by a change in the wavelength distribution patterns, or intensity of absorbance, or a combination of such parameters in a sample.

According to certain embodiment, the hydrolysis product/s of the beta-lactam antibiotics are detected by the method of the invention using a colorimetric method.

The term “colorimetric method” refers herein to methods which employ a chromogenic substrate for enzymatic activity detection and qualitative or quantitative measurement, which may be accomplished by visual comparison of the extent of enzymatic reaction of a substrate in comparison with similarly prepared standards.

Several methods for detecting the presence of microbial beta-lactamase have been developed. For example, chemical methods for the detection of the enzymatic hydrolysis of the beta-lactam ring include: (a) the acidimetric method, which employs a pH color indicator to detect the decrease in pH resulting from the formation of a new carboxyl group; (b) the iodometric method, which is based on the decolorization of a starch-iodine complex by the end products of beta-lactamase hydrolysis, which act as reducing agents to reduce iodine in the complex; and (c) the chromogonic cephalosporin method, which is based on a color change following the hydrolysis of a chromogenic cephalosporin substrate.

Although sensitive, the iodometric method is considered as “fiddly”, difficult to perform, handle, or use [David M. Livermore, 1997, reviewing different assays for detecting resistant bacteria, http://www.bsac.org.uk/_db/downloads_/b-lacs_bsac_London_{—}03.ppt]. Moreover, this method is known in the art as unsuitable for measuring iodine-sensitive beta-lactamase activity [Zyk, N. Antimicrobial agents and chemotherapy, 2:356-359 (1972)]. However, although regarded by the prior art as not suitable for detecting complicated cases involving MDR, carbapenem's resistance and ESBL, the inventor's knowledge and experience with the iodometric method have led to the creation of methods and kits suitable for complicated detection. Thus, unexpectedly, the following examples demonstrate the simple and direct application of the iodometric assay in the methods and kits of the invention. Such rapid and simple performance of the direct detection exemplified by the invention, demonstrates the feasibility of using the methods and kits of the invention in “point of care” (POC) or in any other location where no particular equipment or skilled performers are available. Furthermore, as clearly shown by the following examples, the results indicate high specificity (95.56%) and sensitivity (97.25%), when compared to the conventional laboratory procedure (CLP).

Still further, the iodometric method underlying the preferred embodiments of the present invention was shown by the invention as equally applicable to known beta-lactam antibiotics from different classes and to all known beta-lactamases. Thus familiar problems related to the detection of carbapenamase or profiling of ESBL's by conventional testing [see CDC guidelines] have now been eliminated.

As shown by the following Examples, detection is simply and directly provided using iodometric method. Thus, in a more specific embodiment, the colorimetric method is an iodometric method. According to certain other embodiments, where the iodometric method is used, the end-products of the beta-lactamase hydrolysis act as reducing agents to reduce iodine in the complex thereby resulting in decolorization of the iodine-starch complex added as an indicator.

It is to be appreciated that according to certain embodiments, the colorimetric reaction results are scanned. Moreover, the scanned results are automatically analyzed using an image processing program.

The advantage of immediate detection of a multidrug resistant infection and of the direct establishment of its susceptibility profile is self evident. A further advantage of direct testing is in supplementing otherwise missing information and thus precluding frequent therapeutic failures. For instance, the conventional laboratory tests are not designed to spot resistance conferred by an inducible beta-lactamase. In certain embodiments, the present invention makes it possible to rule out induction by simply retaining an all-negative ART strip [see Table 1] for later inspection. An inducible beta-lactamase will show up after a short delay, typically within 30 min after the living bacteria in the sample made contact with the beta-lactams tested, since each such beta-lactam is an effective inducer of beta-lactamase.

Still further, let us consider a throat swab. The direct test may show that phenoxymethylpenicillin should not be prescribed because it will be rapidly inactivated by beta-lactamase found in the sample. The conventional test will eventually reveal that this is a streptococcal infection and that the pathogen, as expected, is sensitive to phenoxymethylpenicillin. The beta-lactamase present in the sample [and in the throat] is not seen in the conventional test if it is not produced by the pathogen. Thus information that is directly relevant to the treatment has been discarded in the routine step of isolation of the pathogen. This is the source of frequent therapeutic failures that can be avoided by reliance on direct testing.

Conversely, blind avoidance of such therapeutic failures may be even more damaging in the long run. Sinusitis is all too often treated with augmentin, whereas direct testing is likely to reveal that amoxicillin, the drug of choice, will not be broken down and can be safely used. Quite apart from the impressive saving in costs of treatment, avoiding unjustified use of drugs like augmentin should be an overriding consideration in the prudent use of antibiotics.

Thus, by determining an end point indication that is the appearance of detectable hydrolysis products of beta-lactam antibiotics, the method of the invention side-step the need (presented by other prior art methods) of defining different components of the tested sample. For example, methods involving incubation of isolated bacteria reflect only partial analysis of the sample. Similarly, methods focused on determining the existence of a particular beta-lactamase, provide only partial information. In contrast, the methods of the invention, by referring to a whole and unmodified sample, reflect complete and relevant information indicating the resistance of a whole sample to a certain beta-lactam antibiotic. Thus, according to certain embodiments, the method of the invention provides valuable information in cases a sample contain mixed population of different resistant or susceptible microorganisms. In another embodiment, the test sample contains a mixed population of resistant and susceptible bacteria.

One of the major advantages of the invention relays on the direct and rapid identification of beta-lactam resistant bacteria, and particularly, the multi-drug resistant and ESBL. The term “rapid” appears to have varying meanings to microbiologists. The literature lists many papers claiming rapid analysis techniques, where rapid is defined as less than twenty four hours. The present invention relates to the novel methods in which analysis requires less than one hour, more specifically less than thirty minutes and, most specifically, less than 5 minutes. According to certain embodiments, rapid identification is completed within a period of between 30 to 2 minutes. More specifically, the rapid identification according to the invention may be completed within 2, 3, 4, 5, 6, 7, 8, 9, 10, 11, 12, 13, 14, 15, 16, 17, 18, 19, 20, 21, 22, 23, 24, 25, 26, 27, 28, 29 , 30, 35, 40, 45, 50, 55 or 60 minutes.

The disposable, self-contained version of the test (see Examples below) is simple enough to be used at POC, for screening on admission and for subsequent monitoring; for alerting to MDR appearance in vulnerable units such ICU or NICU, for active surveillance, for detecting colonization as well as infection and even as an easily affordable tool for contaminant detection so as to minimize silent MDR transmission.

As used herein, the term “point of care” (POC) and “point of care testing” (POCT) are defined herein as the site of patient care and diagnostic testing at or near the site of patient care, respectively, wherein the testing is accomplished through the use of transportable, portable, and handheld instruments and test kits.

The version of the kit as will be disclosed below has been designed so as to allow the test to be run on a scanner and the results fed into the computer in real time. This will ensure that the entire information can be mailed directly to all concerned and that it will be stored intact for any future reference.

More specifically, as shown by the following Examples and specifically by Examples 3 and 4, the invention provides a modular kit and method for detecting beta-lactam resistant bacteria. Therefore, a third aspect of the present invention relates to a kit for the rapid detection of beta-lactam resistant bacteria in a test sample. Optionally, the kit of the invention may also provide susceptibility profiling of the tested sample.

According to certain embodiments, the kit of the invention may comprise: (a) at least one means for collecting a sample to be tested.

The kit of the invention further comprises (b) at least one compartment containing an array comprising at least one beta-lactam antibiotic of at least one beta-lactam antibiotic class. It should be noted that each of the beta-lactam antibiotics is located in a defined and recorded position in the array. Still further, the kit of the invention includes (c) at least one assay reagent for enabling enzymatic reaction hydrolyzing the beta-lactam antibiotics, specifically, by a beta-lactamase in the sample; (d) at least one means for determining hydrolysis products of the beta-lactam antibiotics; (e) optionally, at least one control sample; and (f) instructions for carrying out the detection of beta-lactam resistant bacteria in the sample.

According to certain embodiments, the kit of the invention may comprise: (a) at least one means for collecting a sample to be tested.

The kit of the invention further comprises (b) at least one compartment containing an array comprising at least one beta-lactam carbapenem antibiotic and optionally at least one beta-lactam antibiotic of at least one other class. It should be noted that each of the beta-lactam antibiotics is located in a defined and recorded position in the array. Still further, the kit of the invention includes (c) at least one assay reagent for enabling enzymatic reaction hydrolyzing the beta-lactam antibiotics, specifically, by a beta-lactamase in the sample; (d) at least one means for determining hydrolysis products of the beta-lactam antibiotics; (e) optionally, at least one control sample; and (f) instructions for carrying out the detection of beta-lactam resistant bacteria in the sample.

In a specific embodiment, the array provided by the kit of the invention (a) may comprise: (i) at least one beta-lactam carbapenem antibiotic and optionally at least one beta-lactam antibiotic of at least one other class or any combinations thereof. Different classes of beta-lactam antibiotics comprised within the kit of the invention may include: (ii) beta-lactam penicillin antibiotics; (iii) beta-lactam cephalosporin antibiotics; (iv) beta-lactam monobactam antibiotics; (v) beta-lactam cephamycin antibiotics; and (vi) beta lactamase inhibitor or a combination of at least one beta-lactam antibiotic of the classes defined in any one of (i) to (v) with a beta-lactamase inhibitor. As indicated above, each of the beta-lactam antibiotics is located in a defined position in the array.

More specifically, the modular array provided by the kits of the invention comprise at least one carbapenem selected from the group of imipenem, meropenem, ertapenem, doripenem, biapenem and PZ-601, and optionally, at least one beta-lactam antibiotics of at least one other class, for example:

at least one cephamycin antibiotic selected from the group of cefoxitin, cefotetan, cefmetazole and flomoxef; at least one monobactam antibiotic selected from the group of aztreonam, tigemonam, nocardicin A and tabtoxin; at least one beta lactam penicillin antibiotic selected from the group of amoxicillin, ampicillin, pivampicillin, hetacillin, bacampicillin, metampicillin, talampicillin, epicillin, carbenicillin, carindacillin, ticarcillin, temocillin, azlocillin, piperacillin, mezlocillin, mecillinam, pivmecillinam, sulbenicillin, clometocillin, benzathine benzylpenicillin, procaine benzylpenicillin, azidocillin, penamecillin, propicillin, benzathine phenoxymethylpenicillin, pheneticillin, cloxacillin, dicloxacillin, flucloxacillin, oxacillin, meticillin and nafcillin; at least one beta lactamase inhibitor from the group of clavulanic acid and its potassium salt, sulbactam and tazobactam; and/or at least one cephalosporin antibiotic selected from the group of cefotetan, cefpodoxime, cefaclor, cefadroxil, cefazolin, cefixime, cefprozil, ceftazidime, cefuroxime, cephalexin, cephalothin, cefuroxime, cefamandole, ceftriaxone, cefotaxime, cefepime and cefpirome.

It should be appreciated that the modular methods and kits of the invention relay on the flexibility of combining and examining different beta-lactam antibiotics.

Also, according to certain embodiments it should be appreciated that the different beta-lactam antibiotics are each attached, embedded, linked, connected, placed etc. to the array in a defined predetermined and recorded position, thereby facilitating a clear and direct identification of the hydrolyzed beta-lactam antibiotics, indicating to which antibiotics the bacteria in the sample are resistant.

According to certain embodiments, detection of the hydrolysis products of a beta-lactam antibiotic located in a defined and recorded position in the array indicates the identity of the beta-lactam antibiotics hydrolyzed by resistant bacteria in the sample. Thereby, the kit of the invention provides susceptibility and resistance profiling of the test sample.

The speed, accuracy, modularity, flexibility and ease of use of the methods and kits of the invention allows for a convenient kit that may be used at points of care as a useful and powerful tool in quick detection of multidrug resistant bacteria, improving clinical outcome. Accordingly, in a fourth aspect, the invention further provides a kit for the rapid detection of the presence of multidrug resistant (MDR) bacteria in a test sample.

According to certain embodiments, the kit of the invention may comprise: (a) at least one means for collecting a sample to be tested; (b) at least one compartment containing an array comprising at least one beta-lactam antibiotic of at least two different classes, wherein each of the beta-lactam antibiotics is located in a defined position in the array; (c) at least one assay reagent for enabling enzymatic reaction hydrolyzing the beta-lactam antibiotics by a beta-lactamase in the sample; (d) at least one means for determining hydrolysis products of the beta-lactam antibiotics; (e) optionally, at least one control sample; and (f) instructions for carrying out the detection of beta-lactam resistant bacteria in the sample.

According to certain embodiments, the kit of the invention may comprise: (a) at least one means for collecting a sample to be tested; (b) at least one compartment containing an array comprising at least one beta-lactam carbapenem antibiotic and at least one beta-lactam antibiotic of at least one other class, wherein each of the beta-lactam antibiotics is located in a defined position in the array; (c) at least one assay reagent for enabling enzymatic reaction hydrolyzing the beta-lactam antibiotics by a beta-lactamase in the sample; (d) at least one means for determining hydrolysis products of the beta-lactam antibiotics; (e) optionally, at least one control sample; and (f) instructions for carrying out the detection of beta-lactam resistant bacteria in the sample.

In a more specific embodiment, the array of (a) provided by the kit of the invention may comprise: (i) at least one beta-lactam carbapenem antibiotic and at least one beta-lactam antibiotic of at least one other class or any combinations thereof. More specifically, such beta-lactam antibiotic classes may comprise: (ii) beta-lactam penicillin antibiotics; (iii) beta-lactam cephalosporin antibiotics; (iv) beta-lactam monobactam antibiotics; (v) beta-lactam cephamycin antibiotics; and (vi) beta lactamase inhibitor or a combination of at least one beta-lactam antibiotics of the classes defined in any one of (i) to (v) with a beta-lactamase inhibitor. It should be noted that each of the beta-lactam antibiotics is located in a defined position in the array.

The term “kit” as used herein refers to a packaged set of related components, typically one or more compounds or compositions.

Yet another embodiment of the present invention is directed to a kit in compartmental form, said kit comprising a compartment adapted to contain one or more arrays.

As indicated herein before, the different beta-lactam antibiotics are spatially arranged in a predetermined and separated location in the array. It should be further noted that any of the reagents included in any of the methods and kits of the invention may be provided as reagents embedded, linked, connected, attached placed or fused to any of the solid support materials described above. For example, the assay reagents in Example 1 are provided in a strip, and in Example 3, the reagents are provided in impregnated filter paper segments glued to a slide.

The different beta-lactam antibiotics are provided by the kits and method of the invention comprised within an array. For example, an array may be a plurality of vessels (test tubes), plates, micro-wells in a micro-plate, each containing a different inhibitory agent or antibody. An array may also be any solid support holding in distinct regions (dots, lines, columns) different and known inhibitory agents or antibodies.

A solid support suitable for use in the kits of the present invention is typically substantially insoluble in liquid phases. Solid supports of the current invention are not limited to a specific type of support. Rather, a large number of supports are available and are known to one of ordinary skill in the art. Thus, useful solid supports include solid and semi-solid matrixes, such as aerogels and hydrogels, resins, beads, biochips (including thin film coated biochips), microfluidic chip, a silicon chip, multi-well plates (also referred to as microtitre plates or microplates), membranes, filters, conducting and nonconducting metals, glass (including microscope slides) and magnetic supports. More specific examples of useful solid supports include silica gels, variously compressed tablets, polymeric membranes, particles, derivatized plastic films, glass beads, cotton, plastic beads, alumina gels, polysaccharides such as Sepharose, nylon, latex bead, magnetic bead, paramagnetic bead, superparamagnetic bead, various filter paper disks, squares or any other segments, starch and the like.

It should be appreciated that the array provided by the kits and methods of the invention may be stored for about one year or more, with or without a desiccant at room temperature or at any suitable temperature, for example, any one of 4° C., 10° C., 15° C., 20° C., 25° C., 30° C. and 35° C.

In all of said test kits said means for collecting a sample to be tested can be a swab, a pipette, or similar collection means and said incubation means can be a liquid or semisolid culture medium placed in a plate, test tube, a glass or plastic surface, a well, or on a strip of absorbent paper, or similar means.

It should be appreciated that any version of the kit has been designed so as to allow the test to be run on a scanner and the results fed into the computer in real time. This will ensure that the entire information can be mailed directly to all concerned and that it will be stored intact for any future reference.

The kits of the invention also include at least one additional component, for example, instructions for using the compound(s) in one or more methods, additional molecules (such as a beta-lactamase used as a positive control), reagents (such as a reaction buffer), or biological components (such as cells, or cell extracts). For example, known susceptible or alternatively, resistant cells (e.g., prokaryotic or eukaryotic cells) which contain beta-lactamase activity, as well as compositions and reaction mixtures which contain such cells can be included in the kits.

In some embodiments, the kit may also include compositions for the quantitative determination of the beta-lactam hydrolysis products in a sample. In an exemplary embodiment, the kit may comprise a sample containing a known amount of a beta-lactamase (such as a solution containing the known amount of beta-lactamase or cells expressing known amounts of the beta-lactamase). The detectable product may be measured and compared to a control as a detectable optical response that is proportional to the amount of the beta-lactamase in the sample. Beta-lactamases that may be included in a kit according to the disclosure can be of any type, and include both naturally-occurring beta-lactamases and non-naturally-occurring beta-lactamase.

Overuse of antibiotics, non-compliance with a full course of antibiotic treatment, routine prophylactic use and sub-therapeutic drug levels all contribute to the development of resistant strains of bacteria. There is thus a need in the art for identifying novel antibacterial agents. Therefore, in a further aspect, the present invention provides a rapid screening method for identification of novel antibiotic agents specifically inhibiting the growth of bacterial cells. This screening method uses the modularity of the array for examining the potential effect of novel, as defined by any of the methods of the invention.

In a particular embodiment, the hydrolysis or degradation product/s of the beta-lactam antibiotics are detected by an iodometric method.

In certain embodiments where the iodometric method being used, the kit of the invention comprises iodine as an assay reagent.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

Disclosed and described, it is to be understood that this invention is not limited to the particular examples, process steps, and materials disclosed herein as such process steps and materials may vary somewhat. It is also to be understood that the terminology used herein is used for the purpose of describing particular embodiments only and not intended to be limiting since the scope of the present invention will be limited only by the appended claims and equivalents thereof.

It must be noted that, as used in this specification and the appended claims, the singular forms “a”, “an” and “the” include plural referents unless the content clearly dictates otherwise.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Unless defined otherwise, all technical and scientific terms used herein have the same meaning as commonly understood by one of ordinary skill in the art to which this invention is related. The following terms are defined for purposes of the invention as described herein.

The following Examples are representative of techniques employed by the inventor in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

### EXAMPLES

### Experimental Procedures

Reagents

Assay Reagent solution—50 mM potassium iodide and 10 mM iodine in 0.75% aqueous starch solution.

Activator solution—40 mg gelatin in 100 mL phosphate buffer pH 6.5.

Antibiotics

Ertapenem [Etp] (purchased from Merck Research Laboratories, Rahway, N.J., USA)

Imipenem [Ipm] (purchased from SIGMA 10160);

Meropenem (purchased from AstraZeneca 8523);

Ceftazidime [Caz] (purchased from SIGMA 3809);

Ceftriaxone [Cro] (purchased from SIGMA C5793);

Cefuroxime [Cxm] (purchased from SIGMA C2128);

Ampicillin [Amp] (purchased from SIGMA A19518);

Augmentin [Amc] (purchased from SmithKleinBeecham).

ART Strip Preparation

Filter paper (Whatman no. 3) strips impregnated with 50 mM potassium iodide and 10 mM iodine in 0.75% aqueous starch solution were divided into 6 test areas. Appropriate antibiotic substrates were prepared at a final concentration of 20 mg/mL. Each test area was impregnated with 30 μL of the appropriate solution. The strips were then dried in a lyophilizer and stored with a desiccant at 4° C.

Sample Preparation

One mL urine samples were spun 2 minutes at 3000 RPM in room temperature. Supernatants were removed and aliquots of the resulting pellets were streaked on standard slides.

Detection of Beta-Lactam Degradation Products

The product of the enzymatic degradation of a beta-lactam antibiotic removes the iodine from the ART strip and causes local decolorization in that strip.
Typically, a detection kit consists of two slides, as illustrated in FIG. 2. The bottom slide is streaked with the sample to be tested. The top slide (lid) carries the ART strip which is activated when each test area on the strip receives 25 μL of the activator solution consisting of 40 mg gelatin in 100 mL phosphate buffer pH 6.5. The test starts when the top slide carrying the freshly activated ART strip contacts the bottom slide carrying the sample. It may be carried out at ambient temperatures but will be accelerated by warming-up to 41° C. Decolorization within the test area, coinciding with segment of contact between the bacterial streak and a beta-lactam antibiotic substrate indicates that the bacteria in the tested sample will inactivate that antibiotic. Result is confirmed if no decolorization took place in the absence of the bacteria (the background of that test area) or in the absence of the antibiotic (as in Test Area 2 in FIG. 1).

### Example 1

### Detection of Carbapenemase Activity in Clinical Samples

In order to optimize detection conditions for clinical samples containing beta-lactamase activity, two beta-lactam antibiotics of the carbapenem family, ertapenem [Ert] and imipenem [Ipm] were used as substrates for detection of carbapenemase activity in urine samples.

Urine samples were concentrated by a two minute centrifugation step at 3000 RPM and the resulting pellet was streaked on standard slides. A strip impregnated with Assay Reagent solution (iodine and starch) and divided into six test areas, each impregnated with a different amount of either Ert or Ipm, as presented in FIG. 1, was attached to a plain slide and placed on a streaked (upper) slide. An identical strip-on-slide was placed on an unstreaked (lower) slide. The respective strip-slide combinations remained in contact for 12 min at room temperature and then scanned for decolorization produced by carbapenem degradation products' uptake of iodine. A streak with a carbapenamase-negative specimen looks exactly like the unstreaked controls (data not shown). As shown by the figure, the carbapenemase activity is easily detected using this method, even in samples containing low concentrations of antibiotic substrates. The test of the invention directly detected the presence of carbapenemase in the sample, hydrolyzing both Ert and Ipm, thus demonstrating the feasibility of rapidly detecting carbapenem resistance in an unprocessed clinical specimen.

### Example 2

### Analysis of Antibiotic Resistance Using the Art of the Invention as Compared to the Conventional Laboratory Procedure (CLP)

In order to test the specificity and sensitivity of the test of the invention, clinical urine samples were analyzed using both the invention's method and conventional lab procedures, and the resulting beta-lactamase activity identifications compared.

One mL urine sample pellets were collected as described in Example 1 and each streaked on a slide. The strip of the invention (termed ART for Antibiotics Resistance Test) was used to test for beta-lactamase and its ability to degrade Ceftazidime [Caz], Ceftriaxone [Cro], Cefuroxime [Cxm] and Ampicillin [Amp]. The strip, containing iodine and starch and divided to areas containing each of the abovementioned antibiotics, and attached to a plain slide, was activated as shown above, and placed on the streaked slide. After 5-15 minutes at 33° C.-38° C. the slide was scanned and recorded.

The same specimens were examined using conventional lab procedures [CLP] that determined the identity of the bacterial isolates and their resistance to the above beta-lactams. These results were recorded manually in the hospital computer.

A comparison of the results is presented in Table 1. Each row represents all samples sharing the resistance profile predicted by ART. The brackets give the number of CLP-confirmed results. Identity of the bacterial isolates determined according to the CLP, is indicated in the table.

The results, based on a total of 334 samples compared, show that ART Sensitivity is 97.25%, Specificity is 95.56%, Positive Predictive Value is 1.03 and Negative Predictive Value is 1.04. Importantly, 100% of all MDR cases were detected by the ART strip immediately, whereas CLP required days to achieve the same results, delaying crucial information for evidence-based treatment.

TABLE 1

| Species / | | | | | |
|---|---|---|---|---|---|
| No. of samples | Caz | Cro | Cxm | Amp | CLP:ART |
| E. coli | | | | | |
| 28 | S[28] | S[28] | S[28] | R[25]* | 109:112* |
| 12 | S[12] | S[12] | S[12] | S[12] | 48:48 |
| 3 | R[3] | R[3] | R[3] | R[3] | 12:12 [MDR] |
| K. pneumoniae | | | | | |
| 11 | R[9]* | R[10] | R[10] | R[10] | 39:42 [MDR] |
| 8 | S[8] | S[8] | S[8] | R[5]* | 29:32* |
| 1 | S | S[R] | R | R | 3:4 |
| K. oxytoca | | | | | |
| 3 | S[3] | S[3] | S[3] | R[3] | 12:12 |
| 1 | S | S[R] | R | R | 3:4 |
| Prot. mirabilis | | | | | |
| 6 | S[6] | S[6] | S[6] | R[3]* | 21:24* |
| 1 | S | S | R | R[S]* | 3:4 |
| 1 | S | R | R | R | 4:4 |
| 1 | R | S | R | R | 4:4 |
| Morg. morganii | | | | | |
| 1 | S | S | S | R | 4:4 |
| 1 | S[R] | R | R | R | 3:4 |
| Citr. koseri | | | | | |
| 2 | S[2] | S[2] | S[2] | R[2] | 8:8 |
| E. faecalis | | | | | |
| 4 | S[nd] | S[nd] | S[nd] | S[4] | 4:4 |
| Acinetobacter sp. | | | | | |
| 1 | S | S | S | S | 4:4 |
| Staphylococcus sp. | | | | | |
| 1 | S | S | S | R | 4:4 |
| 1 | S | S | S | S | 4:4 |
| Str. agalactiae | | | | | |
| 3 | S[nd] | S[nd] | S[nd] | S[3] | 3:3 |

Symbols:
R = resistant;
S = sensitive
nd = no CLP data
MDR = Multidrug resistance
*Presumed false positives; causes now eliminated.

### Example 3

### Modular Antibiotic Substrate Containing Susceptibility Testing Units as an Alternative to the ART Strip

A modular antibiotic resistance detection kit offers more flexibility in testing different resistance profiles. In the modular detection kit exemplified here, the ART strip is replaced by filter paper segments glued to a slide, each segment impregnated with a single antibiotic. An illustrative scheme of such modular kit is shown in FIG. 2.

Specifically, pathogen samples were tested using filter papers impregnated with the following beta-lactam antibiotics: ampicillin [Amp], augmentin (a combination of amoxicillin and clavulanic acid) [AMC], clavulanic acid (Reduced Resistance test) [RR], ceftazidime [Caz] and either imipenem or meropenem [CPM]. The impregnation details of the fragments were as in the previous Examples.

Filter paper (Whatman no. 3] strips impregnated with Assay Reagent solution were used as “indicator strips”. An indicator strip was attached to the plain top slide as shown in FIG. 2. Aliquots of the pellets of the urine samples tested were placed on each of the segments. The test was started by placing the activated indicator-strip-slide, on the modular antibiotic slide. The scan results obtained after 5-10 min at 38° C. are illustrated schematically in FIG. 2 where all segments, except for the negative (no antibiotic) control, show decolorization indicating resistance to each antibiotic in that array.

Results are presented by Table 2. Samples resistant to ceftazidime but affected by clavulanic acid were assumed to contain extended spectrum beta lactamases (ESBLs). The ‘Confirmed’ detections column summarizes the number of CLP-validated results out of the total findings recorded.

As shown by Table 2, out of a total of 118 findings, 116 were in agreement, demonstrating the feasibility of a modular detection kit in rapid and accurate identification of resistant bacteria in a sample. Moreover, this example demonstrates the option of using modular shortcuts as potential signatures of complex resistance profiles such as ESBL.

TABLE 2

| Species/ | | | | | | | Con- |
|---|---|---|---|---|---|---|---|
| No. of samples | Amp | AMC | RR* | CAZ | CPM | ESBL** | firmed |
| E. coli | | | | | | | |
| (16 samples) | S | S | NA | S | S | Neg | 5:5 |
| | S | S | NA | — | S | — | 3:3 |
| | R | S | P | — | S | — | 3:3 |
| | R | R[S] | P | S | S | Neg | 4:5 |
| | R | I | P | S | S | Neg | 15:15 |
| | R | I | M | S | S | Neg | 15:15 |
| | R | I | N | S | S | Neg | 5:5 |
| | R | R | M | — | S | — | 12:12 |
| | R | R | P | R | S | Pos | 5:5 |
| | R | R | M | R | S | Pos | 5:5 |
| K. pneumoniae | | | | | | | |
| (5 samples) | R | I | P | R | S | Pos | 5:5 |
| | R | R | M | R | S | Pos | 5:5 |
| | R | R | M | R[S] | S | — | 4:5 |
| | R | R | N | R | S | Pos | 5:5 |
| | R | S | P | S | S | Neg | 5:5 |
| Citrobacter freundii | | | | | | | |
| | R | R | N | R | S | Pos | 5:5 |
| Proteus mirabilis | | | | | | | |
| (3 samples) | R | I | M | R | S | Pos | 5:5 |
| | R | S | P | R | S | Pos | 5:5 |
| | R | R | M | S | S | Neg | 5:5 |

*Effect of clavulanic acid (Reduced Resistance): P = Powerful; M = Moderate; I = intermediate, N = None or negligible, NA = Not applicable.
**Predicted by the experimental kit and confirmed by CLP
*Presumed false positives; causes now eliminated.
**nd—no CLP data.
R = resistant; S = sensitive; neg. (negative); pos. (positive).

### Example 4

### Detection of Carbapenem-Resistant Members of the Enterobacteriaceae Family

To illustrate the life-saving potential of the proposed technology which eliminates delays in diagnosis of carbapenem-resistant members of the Enterobacteriaceae family (CRE), a CRE sample was analyzed using the invention's modular kit, containing ampicillin, ceftazidime, augmentin, cefotaxime, imipenem, cefuroxime, meropenem and ceftriaxone as beta-lactamase substrates and a non-beta-lactam antibiotic, served as a negative control.

Filter paper segments were glued to a slide, each segment impregnated with a single antibiotic of the abovementioned antibiotics and streaked with carbapenem-resistant Enterobacteriaceae-containing urine sample pellets, prepared as described in Examples 1 to 3. The slide was contacted with indicator strips attached to a slide. After 12 minutes at 38° C., the slide was scanned and recorded, as shown in FIG. 3.

As can be seen, the tested specimen hydrolyzed all eight beta-lactams and clavulanic acid provided no protection from hydrolysis (as is demonstrated by the decolorization produced by hydrolysis of augmentin). This Example demonstrates the speed and ease with which the test can be run [even by untrained personnel in any POC] so that a potentially life-saving decision can be taken without delay. The fundamental differences between the instant invention and the current techniques employed are summarized in Table 3.

TABLE 3

| | | | Invention |
|---|---|---|---|
| | *CLP | **PCR | modular kit |
| Evidence for presence of | Indirect | Indirect | Direct |
| carbapenamase in sample | | | |
| Confirmation | Modified | Not | No need |
| | Hodges Test*** | applicable | |
| Instrumentation/Facilities/Skills | Laboratory | PCR | No need |
| POC diagnosis | No | No | Yes |
| Real time monitoring | No | No | Yes |
| Time from sampling to results | 60 hours | 30 hours | 2-15 |
| | (negative), 75 | | minutes |
| | hours (positive) | | |
| Delay in evidence-based clinical | >2 days or >3 | >1 day | No delay |
| decisions | days | | |

*CLP-conventional lab procedures;
**PCR: the most up to date version;
***.This indirect biological test adds complexity and another day before results are released.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A method for the rapid and direct detection of beta-lactam resistant bacteria in a test sample, and optionally for susceptibility profiling of said sample, said method comprising the steps of:
a) providing an array comprising at least one beta-lactam antibiotic, wherein each of said beta-lactam antibiotics is located in a defined position in said array;
b) contacting aliquots of said test sample with the beta-lactam antibiotics comprised within said array of (a) under conditions allowing enzymatic activity; and
c) directly determining the presence of hydrolysis product/s of the beta-lactam antibiotics comprised within said array of (a) by suitable means;
wherein a positive determination of hydrolysis products of at least one beta-lactam antibiotic comprised within the array of (a) indicates the existence of a beta-lactam hydrolyzing enzyme in the sample, thereby providing the detection of beta-lactam resistant bacteria in said tested sample.

2. The method according to claim 1, wherein said array of (a) comprises at least one beta-lactam antibiotic of at least one class, said beta-lactam classes comprising:
(i) beta-lactam carbapenem antibiotics;
(ii) beta-lactam penicillin antibiotics;
(iii) beta-lactam cephalosporin antibiotics;
(iv) beta-lactam monobactam antibiotics;
(v) beta-lactam cephamycin antibiotics; and
(vi) beta lactamase inhibitor or a combination of at least one beta-lactam antibiotic of the classes defined in any one of (i) to (v) with a beta-lactamase inhibitor; wherein each of said beta-lactam antibiotics is located in a defined position in said array.

3. The method according to claim 1, for the rapid and direct detection of beta-lactam resistant bacteria in a test sample, and optionally for susceptibility profiling of said sample, said method comprising the steps of:
a) providing an array comprising at least one beta-lactam carbapenem antibiotic and optionally at least one beta-lactam antibiotic of at least one other class, wherein each of said beta-lactam antibiotics is located in a defined position in said array;
b) contacting aliquots of said test sample with the beta-lactam antibiotics comprised within said array of (a) under conditions allowing enzymatic activity; and
c) directly determining the presence of hydrolysis product/s of the beta-lactam antibiotics comprised within said array of (a) by suitable means;
wherein a positive determination of hydrolysis products of at least one beta-lactam antibiotic comprised within the array of (a) indicates the existence of a beta-lactam hydrolyzing enzyme in the sample, thereby providing the detection of beta-lactam resistant bacteria in said tested sample.

4. The method according to claim 3, wherein said array of (a) comprises:
(i) at least one beta-lactam carbapenem antibiotic and optionally at least one beta-lactam antibiotics of at least one other class or any combinations thereof, wherein each of said beta-lactam antibiotics is located in a defined position in said array; said beta-lactam classes comprising:
(ii) beta-lactam penicillin antibiotics;
(iii) beta-lactam cephalosporin antibiotics;
(iv) beta-lactam monobactam antibiotics;
(v) beta-lactam cephamycin antibiotics; and
(vi) beta lactamase inhibitor or a combination of at least one beta-lactam antibiotic of the classes defined in any one of (i) to (v) with a beta-lactamase inhibitor.

5. The method according to claim 1, wherein detection of the hydrolysis products of a beta-lactam antibiotic located in a defined and recorded position in the array indicates the identity of the beta-lactam antibiotics hydrolyzed by resistant bacteria in the sample, thereby providing susceptibility and resistance profiling of said test sample.

6. A method for the rapid and direct detection of the presence of multidrug resistant bacteria in a test sample, said method comprising the steps of:
a) providing an array comprising at least one beta-lactam antibiotic of at least two different classes, wherein each of said beta-lactam antibiotic is located in a defined position in said array;
b) contacting aliquots of said test sample with the beta-lactam antibiotics comprised within said array of (a) under conditions allowing enzymatic activity; and
c) directly determining the presence of hydrolysis product/s of the beta-lactam antibiotics comprised within said array of (a) by suitable means;
wherein a positive determination of hydrolysis products of beta-lactam antibiotics from at least two of the beta-lactam antibiotic classes located in the array of (a) indicates the presence of multi-drug resistant bacteria in said tested sample.

7. The method for the rapid and direct detection of the presence of multidrug resistant bacteria in a test sample according to claim 6, said method comprising the steps of:
a) providing an array comprising at least one beta-lactam carbapenem antibiotics and at least one beta-lactam antibiotic of at least one other class, wherein each of said beta-lactam antibiotic is located in a defined position in said array;
b) contacting aliquots of said test sample with the beta-lactam antibiotics comprised within said array of (a) under conditions allowing enzymatic activity; and
c) directly determining the presence of hydrolysis product/s of the beta-lactam antibiotics comprised within said array of (a) by suitable means;
wherein a positive determination of hydrolysis products of beta-lactam antibiotics from at least two of the beta-lactam antibiotic classes located in the array of (a) indicates the presence of a multi-drug resistant bacteria in said tested sample.

8. The method according to claim 7, wherein said array of (a) comprises:
(i) at least one beta-lactam carbapenem antibiotic and at least one beta-lactam antibiotic of at least one other class or any combinations thereof, wherein each of said beta-lactam antibiotics is located in a defined position in said array; said beta-lactam classes comprising:
(ii) beta-lactam penicillin antibiotics;
(iii) beta-lactam cephalosporin antibiotics;
(iv) beta-lactam monobactam antibiotics;
(v) beta-lactam cephamycin antibiotics; and
(vi) beta lactamase inhibitor or a combination of at least one beta-lactam antibiotic of the classes defined in any one of (i) to (v) with a beta-lactamase inhibitor.

9. The method according to claim 1, wherein said test sample contains a mixed population of resistant and susceptible bacteria.

10. The method according to claim 1, wherein the hydrolysis product/s of the beta-lactam antibiotics are detected by a colorimetric method.

11. The method according to claim 10, wherein said colorimetric method is an iodometric method.

12. The method according to claim 1, wherein said rapid identification is completed within a period of between 30 to 2 minutes.

13. A kit for the rapid and direct detection of beta-lactam resistant bacteria in a test sample, and optionally for susceptibility profiling of said sample, said kit comprises:
a) at least one means for collecting a sample to be tested;
b) at least one compartment containing an array comprising at least one beta-lactam antibiotic, wherein each of said beta-lactam antibiotics is located in a defined position in said array;
c) at least one assay reagent for enabling enzymatic reaction hydrolyzing the beta-lactam antibiotics;
d) at least one means for determining hydrolysis products of the beta-lactam antibiotics;
e) optionally, at least one control sample; and
f) instructions for carrying out the detection of beta-lactam resistant bacteria in said sample.

14. The kit according to claim 13, wherein said array of (a) comprises at least one beta-lactam antibiotic of at least one class, said beta-lactam classes comprising:
(i) beta-lactam carbapenem antibiotics;
(ii) beta-lactam penicillin antibiotics;
(iii) beta-lactam cephalosporin antibiotics;
(iv) beta-lactam monobactam antibiotics;
(v) beta-lactam cephamycin antibiotics; and
(vi) beta lactamase inhibitor or a combination of at least one beta-lactam antibiotic of the classes defined in any one of (i) to (v) with a beta-lactamase inhibitor; wherein each of said beta-lactam antibiotics is located in a defined position in said array.

15. The kit according to claim 13, for the rapid and direct detection of beta-lactam resistant bacteria in a test sample, and optionally for susceptibility profiling of said sample, said kit comprises:
a) at least one means for collecting a sample to be tested;
b) at least one compartment containing an array comprising at least one beta-lactam carbapenem antibiotic and optionally at least one beta-lactam antibiotic of at least one other class, wherein each of said beta-lactam antibiotics is located in a defined position in said array;
c) at least one assay reagent for enabling enzymatic reaction hydrolyzing the beta-lactam antibiotics;
d) at least one means for determining hydrolysis products of the beta-lactam antibiotics;
e) optionally, at least one control sample; and
f) instructions for carrying out the detection of beta-lactam resistant bacteria in said sample.

16. The kit according to claim 15, wherein said array of (a) comprises:
(i) at least one beta-lactam carbapenem antibiotic and optionally at least one beta-lactam antibiotic of at least one other class or any combinations thereof, wherein each of said beta-lactam antibiotics is located in a defined position in said array; said beta-lactam classes comprising:
(ii) beta-lactam penicillin antibiotics;
(iii) beta-lactam cephalosporin antibiotics;
(iv) beta-lactam monobactam antibiotics;
(v) beta-lactam cephamycin antibiotics; and
(vi) beta lactamase inhibitor or a combination of at least one beta-lactam antibiotic of the classes defined in any one of (i) to (v) with a beta-lactamase inhibitor.

17. The kit according to claim 14, wherein detection of the hydrolysis products of a beta-lactam antibiotic located in a defined and recorded position in the array indicates the identity of the beta-lactam antibiotics hydrolyzed by resistant bacteria in the sample, thereby providing susceptibility and resistance profiling of said test sample.

18. A kit for the rapid and direct detection of the presence of multidrug resistant bacteria in a test sample, said kit comprises:
a) at least one means for collecting a sample to be tested;
b) at least one compartment containing an array comprising at least one beta-lactam antibiotic of at least two different classes, wherein each of said beta-lactam antibiotic is located in a defined position in said array;
c) at least one assay reagent for enabling enzymatic reaction hydrolyzing the beta-lactam antibiotics;
d) at least one means for determining hydrolysis products of the beta-lactam antibiotics;
e) optionally, at least one control sample; and
f) instructions for carrying out the detection of beta-lactam resistant bacteria in said sample.

19. A kit according to claim 18, for the rapid and direct detection of the presence of multidrug resistant bacteria in a test sample, said kit comprises:
a) at least one means for collecting a sample to be tested;
b) at least one compartment containing an array comprising at least one beta-lactam carbapenem antibiotic and at least one beta-lactam antibiotic of at least one other class, wherein each of said beta-lactam antibiotics is located in a defined position in said array;
c) at least one assay reagent for enabling enzymatic reaction hydrolyzing the beta-lactam antibiotics;
d) at least one means for determining hydrolysis products of the beta-lactam antibiotics;
e) optionally, at least one control sample; and
f) instructions for carrying out the detection of beta-lactam resistant bacteria in said sample.

20. The kit according to claim 19, wherein said array of (a) comprises:
(i) at least one beta-lactam carbapenem antibiotic and at least one beta-lactam antibiotic of at least one other class or any combinations thereof, wherein each of said beta-lactam antibiotics is located in a defined position in said array; said beta-lactam classes comprising:
(ii) beta-lactam penicillin antibiotics;
(iii) beta-lactam cephalosporin antibiotics;
(iv) beta-lactam monobactam antibiotics;
(v) beta-lactam cephamycin antibiotics; and
(vi) beta lactamase inhibitor or a combination of at least one beta-lactam antibiotics of the classes defined in any one of (i) to (v) with a beta-lactamase inhibitor.

21. The kit according to claim 13, wherein the hydrolysis product/s of the beta-lactam antibiotics are detected by an iodometric method.
